(19) United States
(12) Patent Application Publication
(10) Pub. No.: US 2003/0079032 A1
(43) Pub. Date: Apr. 24, 2003

(54) Enterprise software gateway

(76) Inventors: John Orsolits, Peachtree City, GA (US); Umut Alev, Redmond, WA (US); Glen Jones, Dallas, GA (US); Bill Sexton, Alpharetta, GA (US); David Alexander, Roswell, GA (US); James Greenwood, Atlanta, GA (US); Ginny Haines, Woodstock, GA (US); Chengxian He, Alpharetta, GA (US); Leonid Kutikov, Atlanta, GA (US); William Jerry Linch, Norcross, GA (US); Michael Moore, Fayetteville, GA (US); Barry Schempp, Canton, GA (US); Ron Yarbrough, Smyrna, GA (US)

Correspondence Address: THOMAS B. LUEBBERING, HOVEY, WILLIAMS, TIMMONS & COLLINS, 2405 Grand, Suite 400, Kansas City, MO, 64108, US

(21) Appl. No.: 09/950,128

(22) Filed: Sep. 10, 2001

(51) Int. Cl. G06F 15/16

(52) U.S. Cl. 709/230

(57) ABSTRACT

An enterprise software gateway, or interface, operable to remotely facilitate, by transparently performing protocol conversion and managing communication, access to a host system (22), such as a mainframe legacy system, by a client application or device (24), including software applications and input/output (I/O) devices. A viewer (28) is provided to allow for remote monitoring of interactions, including communication, between the host (22) and client (24), and to allow for remote configuration and control of the software gateway, thereby facilitating problem diagnosis and solution.

### COMPUTER PROGRAM LISTING APPENDIX

A computer program listing appendix containing the source code of a computer program that may be used with the present invention is incorporated herein by reference and appended hereto as one (1) original compact disk, and an identical copy thereof, containing a total of One Thousand Four Hundred Sixty-One (1,461) files as follows:

| Date of Creation: | Size (Bytes): | Filename: |
|---|---|---|
| Jan. 23, 1999 04:16 a | 472 | ABOUT.HTM |
| Jun. 22, 2000 11:24 a | 874 | ABOUTD_8.JAV |
| Apr. 26, 1999 02:51 p | 2,698 | ADDTO_10.CPP |
| Apr. 26, 1999 02:54 p | 530 | ADDTO_12.H |
| Jun. 4, 1999 03:38 p | 57,957 | ADMIN_14.CPP |
| Apr. 16, 1999 04:00 p | 7,924 | ADMIN_16.H |
| Jun. 15, 1998 12:00 a | 19,097 | AFXIMPL.H |
| Jun. 28, 1999 04:32 p | 33,126 | AGENCYPG.CPP |
| Jul. 21, 1999 03:35 p | 7,512 | AGENCYPG.H |
| May 28, 1999 12:39 p | 65,830 | AGENC_24.CPP |
| May 25, 1999 04:05 p | 16,518 | AGENC_26.H |
| Jul. 21, 1999 04:19 p | 14,570 | AGENC_28.CPP |
| Apr. 15, 1999 10:41 a | 3,991 | AGENC_30.H |
| Jul. 19, 1999 04:20 p | 7,854 | APPCA_32.CPP |
| Apr. 15, 1999 12:19 p | 5,897 | APPCA_34.H |
| Jul. 19, 1999 04:26 p | 18,287 | APPCB_36.CPP |
| Apr. 15, 1999 01:58 p | 5,560 | APPCB_38.H |
| Sep. 1, 2000 05:45 p | 40,156 | ASSOCPG.CPP |
| Jul. 21, 1999 03:38 p | 7,512 | ASSOCPG.H |
| Jun. 3, 1999 03:03 p | 12,394 | ASSOC_40.CPP |
| Apr. 15, 1999 10:52 a | 3,595 | ASSOC_42.H |
| Jun. 27, 2000 05:28 p | 3,215 | ATL_T_48.H |
| Apr. 14, 2000 12:54 p | 956 | ATL_UTIL.H |
| Apr. 21, 2000 01:47 p | 6,365 | ATL_U_52.H |
| Feb. 16, 2001 11:56 a | 6,465 | ATL_W_54.H |
| Apr. 16, 1999 04:56 p | 4,816 | AUTHENPG.CPP |
| Jul. 21, 1999 03:35 p | 4,245 | AUTHENPG.H |
| Jun. 2, 1999 02:20 p | 553 | AUTOC_60.HTM |
| Jun. 2, 1999 02:15 p | 1,373 | AUTOC_62.HTM |
| Jun. 2, 1999 02:14 p | 537 | AUTOC_64.HTM |
| Jan. 5, 1999 07:36 p | 819 | AUTOH_66.MAK |
| Sep. 28, 1999 11:03 a | 9,868 | BASEC_68.H |
| Jul. 24, 2000 10:55 a | 20,413 | CAPTU_70.CPP |
| Jul. 24, 2000 10:54 a | 8,977 | CAPTU_72.H |
| Feb. 12, 1999 09:13 p | 517 | CAPTU_74.HTM |
| Feb. 15, 1999 01:33 p | 667 | CAPTU_76.HTM |
| Feb. 15, 1999 02:02 p | 204 | CAPTU_78.HTM |
| Jun. 3, 1999 03:03 p | 1,743 | CASDI_80.CPP |
| Apr. 15, 1999 11:04 a | 2,600 | CASDI_82.H |
| Aug. 17, 2000 03:20 p | 6,304 | CAT32.CPP |
| Aug. 30, 2000 05:07 p | 8,787 | CAT32.DSP |
| Jul. 31, 2000 02:59 p | 1,475 | CAT32.H |
| Aug. 17, 2000 12:31 p | 15,180 | CAT32.RC |
| Apr. 16, 1999 01:35 p | 397 | CAT32.RC2 |
| Jul. 28, 2000 12:12 p | 3,683 | CAT32_94.H |
| Aug. 15, 2000 01:33 p | 5,324 | CATBR_96.CPP |
| Jun. 2, 1999 02:15 p | 1,287 | CATBR_98.H |
| Apr. 19, 2001 12:55 p | 64,609 | CDDP.CPP |
| Apr. 19, 2001 10:29 a | 36,576 | CDDP.H |
| Aug. 23, 1999 03:02 p | 5,342 | CDSADDDA.CPP |
| Sep. 27, 1999 10:13 a | 2,409 | CDSADDDA.HPP |
| Oct. 5, 2000 03:27 p | 19,058 | CDSADM.CPP |
| Jul. 21, 1999 03:35 p | 6,098 | CDSADM.H |
| Sep. 1, 2000 05:45 p | 8,553 | CDSADMIN.DSP |
| Feb. 11, 2000 01:11 p | 34,691 | CDSADMIN.RC |
| Jan. 28, 1998 03:07 p | 400 | CDSADMIN.RC2 |
| Aug. 24, 1999 05:28 p | 2,127 | CDSA_104.CPP |
| Aug. 23, 1999 03:00 p | 19,065 | CDSA_110.CPP |
| Jul. 20, 1999 02:01 p | 5,288 | CDSA_112.HPP |
| Aug. 23, 1999 03:01 p | 3,604 | CDSA_114.CPP |
| Aug. 10, 1999 11:37 a | 3,390 | CDSA_116.HPP |
| Aug. 23, 1999 03:02 p | 4,493 | CDSA_118.CPP |
| Sep. 27, 1999 09:16 a | 3,587 | CDSA_120.HPP |
| Aug. 23, 1999 03:03 p | 4,749 | CDSA_122.CPP |
| Jul. 8, 1999 03:09 p | 2,239 | CDSA_124.HPP |
| Aug. 23, 1999 03:04 p | 4,347 | CDSA_126.CPP |
| Aug. 9, 1999 12:29 p | 2,021 | CDSA_128.HPP |
| Aug. 23, 1999 03:05 p | 12,602 | CDSA_130.CPP |
| Jul. 8, 1999 03:43 p | 3,648 | CDSA_132.HPP |
| Aug. 23, 1999 03:09 p | 5,284 | CDSA_134.CPP |
| Jul. 8, 1999 03:49 p | 2,303 | CDSA_136.HPP |
| Aug. 23, 1999 03:11 p | 3,502 | CDSA_138.CPP |
| Aug. 16, 1999 10:57 a | 3,146 | CDSA_140.HPP |
| Aug. 23, 1999 03:05 p | 3,897 | CDSA_142.CPP |
| Aug. 23, 1999 11:46 a | 3,313 | CDSA_144.HPP |
| Jun. 4, 1999 05:37 p | 33,319 | CDSA_156.CPP |
| Jul. 21, 1999 03:36 p | 7,112 | CDSA_158.H |
| Apr. 16, 1999 04:36 p | 9,331 | CDSA_160.CPP |
| Jul. 21, 1999 03:36 p | 5,871 | CDSA_162.H |
| Aug. 23, 1999 03:11 p | 7,255 | CDSA_164.CPP |
| Sep. 27, 1999 10:27 a | 2,783 | CDSA_166.HPP |
| Aug. 23, 1999 03:12 p | 3,541 | CDSA_168.CPP |
| Sep. 27, 1999 10:28 a | 3,207 | CDSA_170.HPP |
| Sep. 10, 1999 09:16 a | 9,344 | CDSA_172.CPP |
| Jul. 8, 1999 05:24 p | 2,685 | CDSA_174.HPP |
| Sep. 10, 1999 09:18 a | 4,396 | CDSA_176.CPP |
| Aug. 13, 1999 10:52 a | 3,099 | CDSA_178.HPP |
| Aug. 23, 1999 03:13 p | 8,187 | CDSA_180.CPP |
| Sep. 27, 1999 10:29 a | 2,967 | CDSA_182.HPP |
| Aug. 23, 1999 03:14 p | 4,470 | CDSA_184.CPP |
| Sep. 27, 1999 10:34 a | 2,213 | CDSA_186.HPP |
| Jun. 29, 2000 03:55 p | 8,366 | CDSA_188.CPP |
| Sep. 24, 1998 09:52 a | 4,546 | CDSA_190.H |
| Jun. 29, 2000 03:55 p | 11,198 | CDSA_192.CPP |
| Sep. 24, 1998 09:03 a | 3,623 | CDSA_194.H |
| May 26, 1999 01:14 p | 3,427 | CDSA_196.CPP |
| May 26, 1999 01:05 p | 5,273 | CDSA_198.H |
| Jun. 29, 2000 03:55 p | 12,100 | CDSA_200.CPP |
| Sep. 24, 1998 10:00 a | 4,209 | CDSA_202.H |
| Jun. 30, 2000 11:10 a | 5,096 | CDSC_204.CPP |
| Aug. 23, 1999 03:20 p | 9,044 | CDSC_206.CPP |
| Dec. 15, 1998 11:44 a | 1,286 | CDSC_208.HPP |
| Aug. 23, 1999 03:22 p | 3,408 | CDSC_210.CPP |
| Dec. 28, 1998 11:21 a | 1,440 | CDSC_212.HPP |
| Jul. 19, 2000 12:04 p | 44,869 | CDSC_214.CPP |
| Jan. 28, 1999 12:19 p | 420 | CDSC_216.DEF |
| Aug. 30, 2000 03:17 p | 29,388 | CDSC_218.DSP |
| Jul. 19, 1999 02:53 p | 9,157 | CDSC_220.H |
| Aug. 23, 1999 11:16 a | 50,132 | CDSC_222.HPP |
| Nov. 10, 1998 06:28 p | 19,966 | CDSC_224.MAK |
| Aug. 7, 2000 10:00 p | 7,843 | CDSC_226.RC |
| Feb. 16, 1998 06:07 p | 404 | CDSC_228.RC2 |
| May 22, 2000 05:27 p | 48,755 | CDSC_230.CPP |
| Aug. 30, 2000 05:14 p | 7,300 | CDSC_232.DSP |
| Jan. 22, 2001 09:54 a | 15,639 | CDSC_234.CPP |
| Dec. 28, 1998 11:24 a | 1,548 | CDSC_236.HPP |
| Aug. 23, 1999 03:28 p | 4,778 | CDSC_238.CPP |
| Aug. 10, 1999 11:32 a | 2,340 | CDSC_240.HPP |
| Aug. 23, 1999 03:27 p | 2,785 | CDSC_242.CPP |
| Aug. 20, 1998 05:21 p | 5,262 | CDSC_244.CPP |
| Aug. 17, 1998 04:31 p | 1,214 | CDSC_246.HPP |
| Sep. 14, 1998 07:37 p | 4,781 | CDSC_248.CPP |
| Sep. 14, 1998 07:17 p | 1,275 | CDSC_250.HPP |
| Aug. 23, 1999 03:29 p | 7,097 | CDSC_252.CPP |
| Sep. 27, 1999 10:37 a | 3,065 | CDSC_254.HPP |
| Aug. 23, 1999 03:30 p | 3,877 | CDSC_256.CPP |
| Sep. 27, 1999 01:30 p | 3,411 | CDSC_258.HPP |
| May 27, 1999 03:57 p | 2,584 | CDSC_260.CPP |
| Apr. 26, 1999 02:52 p | 3,797 | CDSC_262.H |
| Mar. 16, 1998 04:44 p | 608 | CDSC_264.CPP |
| Mar. 16, 1998 05:25 p | 1,200 | CDSC_266.H |
| May 27, 1999 03:57 p | 2,315 | CDSC_268.CPP |
| May 27, 1999 03:57 p | 3,190 | CDSC_270.H |
| Jun. 29, 2000 03:55 p | 9,732 | CDSDASET.CPP |
| Jan. 20, 2000 10:53 a | 3,881 | CDSDASET.H |
| Jun. 30, 2000 11:36 a | 2,196 | CDSDATA.H |
| Apr. 28, 2000 05:27 p | 3,732 | CDSDIRMQ.CPP |
| Jul. 9, 1999 12:44 p | 1,465 | CDSDIRMQ.HPP |
| May 26, 1999 01:11 p | 3,461 | CDSD_272.CPP |
| May 26, 1999 01:09 p | 4,570 | CDSD_274.H |
| Jun. 29, 2000 03:55 p | 29,740 | CDSD_282.CPP |
| Jun. 30, 2000 11:19 a | 2,767 | CDSD_284.CPP |
| Jun. 29, 2000 03:55 p | 17,114 | CDSD_286.CPP |
| Apr. 11, 2001 02:36 p | 33,344 | CDSD_288.CPP |
| Jun. 29, 2000 03:55 p | 2,078 | CDSD_290.CPP |
| Jun. 29, 2000 03:55 p | 18,322 | CDSD_292.CPP |
| Jun. 29, 2000 03:55 p | 35,352 | CDSD_294.CPP |
| Jun. 29, 2000 03:55 p | 33,269 | CDSD_296.CPP |
| Jun. 29, 2000 03:27 p | 30,591 | CDSD_298.CPP |
| May 24, 2000 11:02 a | 9,106 | CDSD_300.H |
| Jun. 29, 2000 03:55 p | 25,157 | CDSD_302.CPP |
| Jun. 29, 2000 03:55 p | 21,846 | CDSD_304.CPP |
| Jun. 29, 2000 03:39 p | 13,455 | CDSD_306.CPP |
| Jun. 29, 2000 03:55 p | 2,054 | CDSD_308.CPP |
| Jun. 30, 2000 11:12 a | 22,242 | CDSD_310.CPP |
| Jul. 24, 2000 02:52 p | 72,822 | CDSD_312.CPP |
| Aug. 23, 1999 03:31 p | 6,550 | CDSD_314.CPP |
| Jul. 9, 1999 11:05 a | 2,046 | CDSD_316.HPP |
| Aug. 23, 1999 03:33 p | 3,069 | CDSD_318.CPP |
| Aug. 23, 1999 11:46 a | 3,084 | CDSD_320.HPP |
| Aug. 23, 1999 03:34 p | 4,398 | CDSD_322.CPP |
| Jul. 12, 1999 11:44 a | 1,875 | CDSD_324.HPP |
| Aug. 23, 1999 03:44 p | 3,451 | CDSD_326.CPP |
| Aug. 10, 1999 11:32 a | 3,253 | CDSD_328.HPP |
| Aug. 23, 1999 03:45 p | 4,593 | CDSD_330.CPP |
| Jul. 9, 1999 11:11 a | 2,004 | CDSD_332.HPP |
| Aug. 23, 1999 03:45 p | 3,564 | CDSD_334.CPP |
| Jul. 9, 1999 11:12 a | 2,011 | CDSD_336.HPP |
| Aug. 23, 1999 03:46 p | 7,165 | CDSD_338.CPP |
| Jul. 9, 1999 11:20 a | 2,197 | CDSD_340.HPP |
| Jul. 9, 1999 11:26 a | 6,146 | CDSD_342.CPP |
| Jul. 9, 1999 11:28 a | 2,309 | CDSD_344.HPP |
| Jul. 9, 1999 11:29 a | 3,191 | CDSD_346.CPP |
| Aug. 23, 1999 11:47 a | 3,261 | CDSD_348.HPP |
| Aug. 23, 1999 03:46 p | 3,099 | CDSD_350.CPP |
| Aug. 23, 1999 11:48 a | 2,841 | CDSD_352.HPP |
| Aug. 23, 1999 03:47 p | 4,336 | CDSD_354.CPP |
| Sep. 28, 1999 10:07 a | 2,048 | CDSD_356.HPP |
| Aug. 23, 1999 03:48 p | 2,983 | CDSD_358.CPP |
| Aug. 19, 1999 04:39 p | 2,819 | CDSD_360.HPP |
| Aug. 23, 1999 03:49 p | 4,305 | CDSD_362.CPP |
| Sep. 28, 1999 10:12 a | 1,954 | CDSD_364.HPP |
| Aug. 23, 1999 03:49 p | 3,534 | CDSD_366.CPP |
| Aug. 20, 1999 12:39 p | 3,089 | CDSD_368.HPP |
| Sep. 10, 1999 09:17 a | 7,670 | CDSD_370.CPP |
| Jul. 9, 1999 11:53 a | 2,278 | CDSD_372.HPP |
| Sep. 10, 1999 09:18 a | 4,277 | CDSD_374.CPP |
| Aug. 13, 1999 10:26 a | 3,066 | CDSD_376.HPP |
| Aug. 23, 1999 02:58 p | 4,870 | CDSD_378.CPP |
| Sep. 28, 1999 10:12 a | 2,269 | CDSD_380.HPP |
| Aug. 23, 1999 02:01 p | 3,795 | CDSD_382.CPP |
| Jul. 12, 1999 11:48 a | 1,933 | CDSD_384.HPP |
| Aug. 23, 1999 03:01 p | 5,361 | CDSD_390.CPP |
| May 27, 1999 03:57 p | 4,384 | CDSD_392.H |
| Aug. 16, 1999 09:01 a | 3,647 | CDSD_394.HPP |
| May 27, 1999 03:57 p | 2,799 | CDSD_396.CPP |
| May 27, 1999 03:57 p | 2,523 | CDSD_398.CPP |
| May 28, 1999 10:27 a | 3,781 | CDSD_400.H |
| Oct. 20, 2000 08:49 a | 37,532 | CDSF_402.CPP |
| Oct. 28, 1998 05:26 p | 15,857 | CDSF_404.HPP |
| Oct. 20, 2000 08:49 a | 24,280 | CDSF_406.CPP |
| Aug. 19, 1999 03:03 p | 13,822 | CDSF_408.HPP |
| Oct. 20, 2000 08:48 a | 41,186 | CDSF_410.CPP |
| Oct. 28, 1998 05:28 p | 17,356 | CDSF_412.HPP |
| Jan. 21, 1999 04:02 p | 23,866 | CDSF_414.CPP |
| Aug. 19, 1999 03:04 p | 13,824 | CDSF_416.HPP |
| May 26, 1999 01:02 p | 2,769 | CDSG_418.CPP |
| May 26, 1999, 01:05 p | 3,925 | CDSG_420.H |
| Feb. 10, 1999 12:24 p | 12,472 | CDSG_422.CPP |
| Sep. 24, 1998 10:03 a | 4,050 | CDSG_424.H |
| Mar. 1, 2000 04:03 p | 8,189 | CDSG_426.CPP |
| Mar. 16, 2000 05:54 p | 3,687 | CDSG_428.H |
| Mar. 16, 2000 05:46 p | 7,366 | CDSG_430.CPP |
| Mar. 16, 2000 05:55 p | 3,558 | CDSG_432.H |
| May 26, 1999 01:02 p | 3,353 | CDSG_434.CPP |
| May 26, 1999 01:05 p | 4,519 | CDSG_436.H |
| Feb. 18, 1999 06:19 p | 12,297 | CDSG_438.CPP |
| Feb. 18, 1999 06:19 p | 4,269 | CDSG_440.H |
| Sep. 13, 1999 12:31 p | 4,654 | CDSG_442.CPP |
| Sep. 13, 1999 12:37 p | 2,981 | CDSG_444.HPP |
| Sep. 13, 1999 12:35 p | 12,465 | CDSG_446.CPP |
| Sep. 13, 1999 12:36 p | 5,787 | CDSG_448.HPP |
| Aug. 23, 1999 04:06 p | 3,397 | CDSG_450.CPP |
| Jul. 9, 1999 02:43 p | 1,443 | CDSG_452.HPP |
| Aug. 23, 1999 04:07 p | 3,664 | CDSD_454.CPP |
| Jul. 9, 1999 02:43 p | 1,546 | CDSG_456.HPP |
| Jan. 21, 1999 04:05 p | 15,968 | CDSG_458.CPP |
| Nov. 4, 1998 11:17 a | 4,171 | CDSG_460.HPP |
| Jan. 21, 1999 04:06 p | 12,448 | CDSG_462.CPP |
| Aug. 10, 1999 11:30 a | 6,771 | CDSG_464.HPP |
| Jan. 21, 1999 04:09 p | 19,972 | CDSG_466.CPP |
| Nov. 17, 1998 01:34 p | 12,548 | CDSG_468.HPP |
| Jan. 21, 1999 04:09 p | 20,108 | CDSG_470.CPP |
| Aug. 10, 1999 11:30 a | 11,243 | CDSG_472.HPP |
| Aug. 20, 1998 05:29 p | 4,688 | CDSG_474.CPP |
| Aug. 17, 1998 04:42 p | 1,079 | CDSG_476.HPP |
| Sep. 14, 1998 07:36 p | 4,341 | CDSG_478.CPP |
| Sep. 14, 1998 07:21 p | 1,163 | CDSG_480.HPP |
| Aug. 23, 1999 04:08 p | 4,496 | CDSG_482.CPP |
| Sep. 28, 1999 10:12 a | 2,212 | CDSG_484.HPP |
| Aug. 23, 1999 04:10 p | 3,699 | CDSG_486.CPP |
| Aug. 10, 1999 11:29 a | 3,375 | CDSG_488.HPP |
| Aug. 23, 1999 04:11 p | 4,706 | CDSG_490.CPP |
| Sep. 28, 1999 10:12 a | 2,389 | CDSG_492.HPP |
| Aug. 23, 1999 04:11 p | 3,798 | CDSG_494.CPP |
| Aug. 10, 1999 03:27 p | 2,764 | CDSG_496.HPP |
| Aug. 23, 1999 04:13 p | 7,582 | CDSG_498.CPP |
| Jul. 9, 1999 03:04 p | 1,852 | CDSG_500.HPP |
| Sep. 10, 1999 09:29 a | 7,736 | CDSG_502.CPP |
| Jul. 9, 1999 03:05 p | 1,864 | CDSG_504.HPP |
| Aug. 20, 1998 05:29 p | 5,373 | CDSG_506.CPP |
| Aug. 17, 1998 04:47 p | 1,223 | CDSG_508.HPP |
| Sep. 14, 1998 07:35 p | 4,975 | CDSG_510.CPP |
| Aug. 16, 1999 10:58 a | 2,417 | CDSG_512.HPP |
| Aug. 24, 1999 10:28 a | 4,781 | CDSG_514.CPP |
| Sep. 28, 1999 10:12 a | 1,702 | CDSG_516.HPP |
| Aug. 24, 1999 10:28 a | 3,309 | CDSG_518.CPP |
| Jul. 30, 1999 02:41 p | 3,241 | CDSG_520.HPP |
| Sep. 10, 1999 09:30 a | 8,433 | CDSG_522.CPP |
| Jul. 9, 1999 03:09 p | 1,762 | CDSG_524.HPP |
| Sep. 10, 1999 09:32 a | 11,495 | CDSG_526.CPP |
| Jul. 30, 1999 03:45 p | 5,658 | CDSG_528.HPP |
| Aug. 24, 1999 10:41 a | 4,548 | CDSG_530.CPP |
| Jul. 9, 1999 03:11 p | 1,637 | CDSG_532.HPP |
| Aug. 24, 1999 10:44 a | 5,392 | CDSG_534.CPP |
| Jul. 9, 1999 03:11 p | 1,725 | CDSG_536.HPP |
| Aug. 23, 1999 01:58 p | 3,800 | CDSG_538.GPP |
| Aug. 23, 1999 12:15 p | 4,611 | CDSG_540.HPP |
| Aug. 20, 1998 05:29 p | 4,681 | CDSG_542.CPP |
| Aug. 17, 1998 04:48 p | 1,072 | CDSG_544.HPP |
| Sep. 14, 1998 07:35 p | 4,345 | CDSG_546.CPP |
| Sep. 14, 1998 07:22 p | 1,161 | CDSG_548.HPP |
| Aug. 24, 1999 10:42 a | 3,147 | CDSG_550.CPP |
| Aug. 23, 1999 12:14 p | 4,642 | CDSG_552.HPP |
| Mar. 16, 2000 03:59 p | 31,645 | CDSG_554.CPP |
| Mar. 16, 2000 04:00 p | 11,399 | CDSG_556.HPP |
| Mar. 16, 2000 04:00 p | 15,890 | CDSG_558.CPP |
| Mar. 16, 2000 04:00 p | 10,489 | CDSG_560.HPP |
| Aug. 24, 1999 10:49 a | 4,654 | CDSG_562.CPP |
| Jul. 9, 1999 03:13 p | 1,606 | CDSG_564.HPP |
| Aug. 24, 1999 10:50 a | 3,220 | CDSG_566.CPP |
| Aug. 19, 1999 04:34 p | 3,099 | CDSG_568.HPP |
| Mar. 16, 2000 12:03 p | 25,639 | CDSG_570.CPP |
| Mar. 16, 2000 11:57 a | 11,118 | CDSG_572.HPP |
| Mar. 16, 2000 03:56 p | 14,949 | CDSG_574.CPP |
| Mar. 16, 2000 10:31 a | 10,237 | CDSG_576.HPP |
| Aug. 24, 1999 11:03 a | 3,286 | CDSG_578.CPP |
| Jul. 9, 1999 03:15 p | 1,533 | CDSG_580.HPP |
| Aug. 24, 1999 11:03 a | 3,366 | CDSG_582.CPP |
| Jul. 9, 1999 03:16 p | 1,681 | CDSG_584.HPP |
| Aug. 24, 1999 11:05 a | 4,628 | CDSG_586.CPP |
| Sep. 13, 1999 12:38 p | 2,856 | CDSG_588.HPP |
| Aug. 24, 1999 11:06 a | 3,746 | CDSG_590.CPP |
| Aug. 20, 1999 12:40 p | 3,202 | CDSG_592.HPP |
| Sep. 10, 1999 09:46 a | 6,525 | CDSG_594.CPP |
| Jul. 9, 1999 03:21 p | 1,987 | CDSG_596.HPP |
| Sep. 10, 1999 09:46 a | 4,496 | CDSG_598.CPP |
| Jul. 9, 1999 03:22 p | 1,749 | CDSG_600.HPP |
| Jan. 21, 1999 04:20 p | 20,235 | CDSG_602.CPP |
| Nov. 13, 1998 12:56 p | 12,558 | CDSG_604.HPP |
| Jan. 21, 1999 04:21 p | 16,657 | CDSG_606.CPP |
| Nov. 3, 1998 06:05 p | 11,272 | CDSG_608.HPP |
| Aug. 24, 1999 11:22 a | 5,050 | CDSG_610.CPP |
| Sep. 28, 1999 10:28 a | 2,036 | CDSG_612.HPP |
| Aug. 20, 1998 05:32 p | 5,327 | CDSG_614.CPP |
| Aug. 17, 1998 04:57 p | 1,158 | CDSG_616.HPP |
| Sep. 14, 1998 07:35 p | 4,674 | CDSG_618.CPP |
| Sep. 14, 1998 07:24 p | 1,260 | CDSG_620.HPP |
| Mar. 14, 2000 02:41 p | 18,470 | CDSG_622.CPP |
| Mar. 14, 2000 12:16 p | 2,324 | CDSG_624.HPP |
| Mar. 14, 2000 03:50 p | 4,078 | CDSG_626.CPP |
| May 16, 2000 11:27 p | 4,473 | CDSG_628.HPP |
| Aug. 24, 1999 11:23 a | 3,757 | CDSG_630.CPP |
| Aug. 12, 1999 06:02 p | 3,815 | CDSG_632.HPP |
| Aug. 24, 1999 11:24 a | 4,877 | CDSG_634.CPP |
| Sep. 28, 1999 10:28 a | 2,339 | CDSG_636.HPP |
| Aug. 24, 1999 11:28 a | 3,987 | CDSG_638.CPP |
| Jul. 9, 1999 03:28 p | 2,268 | CDSG_640.HPP |
| Aug. 24, 1999 11:27 a | 4,848 | CDSG_642.CPP |
| Jul. 9, 1999 03:31 p | 2,522 | CDSG_644.HPP |
| Aug. 24, 1999 11:29 a | 6,186 | CDSG_646.CPP |
| Jul. 9, 1999 03:36 p | 3,559 | CDSG_648.HPP |
| Aug. 24, 1999 11:30 a | 18,610 | CDSG_650.CPP |
| Nov. 18, 1998 02:47 p | 11,283 | CDSG_652.HPP |
| Aug. 24, 1999 11:31 a | 15,995 | CDSG_654.CPP |
| Nov. 3, 1998 06:07 p | 10,354 | CDSG_656.HPP |
| Aug. 24, 1999 11:34 a | 3,163 | CDSG_658.CPP |
| Jul. 9, 1999 03:39 p | 1,276 | CDSG_660.HPP |
| Aug. 24, 1999 11:34 a | 4,828 | CDSG_662.CPP |
| Aug. 10, 1999 11:30 a | 3,116 | CDSG_664.HPP |
| Aug. 24, 1999 11:38 a | 4,643 | CDSG_666.CPP |
| Sep. 27, 1999 10:15 a | 2,132 | CDSG_668.HPP |
| Jan. 20, 2000 09:58 a | 5,667 | CDSG_670.CPP |
| Jan. 20, 2000 09:53 a | 4,175 | CDSG_672.HPP |
| Aug. 24, 1999 02:07 p | 4,583 | CDSG_674.CPP |
| Sep. 28, 1999 10:28 a | 2,231 | CDSG_676.HPP |
| Aug. 24, 1999 02:07 p | 5,621 | CDSG_678.CPP |
| Sep. 28, 1999 10:28 a | 2,041 | CDSG_680.HPP |
| Aug. 24, 1999 02:09 p | 5,554 | CDSG_682.CPP |
| Jul. 9, 1999 03:46 p | 1,981 | CDSG_684.HPP |
| Aug. 24, 1999 02:18 p | 5,263 | CDSG_686.CPP |
| Jul. 9, 1999 03:47 p | 2,009 | CDSG_688.HPP |
| Aug. 24, 1999 03:58 p | 4,700 | CDSG_690.CPP |
| Sep. 28, 1999 10:28 a | 1,718 | CDSG_692.HPP |
| Aug. 24, 1999 04:41 p | 11,378 | CDSG_694.CPP |
| Sep. 28, 1999 10:28 a | 6,677 | CDSG_696.HPP |
| Aug. 24, 1999 04:52 p | 4,530 | CDSG_698.CPP |
| Sep. 13, 1999 12:39 p | 2,971 | CDSG_700.HPP |
| Aug. 24, 1999 04:53 p | 6,988 | CDSG_702.CPP |
| Sep. 28, 1999 10:28 a | 5,584 | CDSG_704.HPP |
| Aug. 24, 1999 04:54 p | 4,548 | CDSG_706.CPP |
| Sep. 13, 1999 12:42 p | 3,154 | CDSG_708.HPP |
| Aug. 24, 1999 04:56 p | 7,393 | CDSG_710.CPP |
| Sep. 28, 1999 10:28 a | 5,084 | CDSG_712.HPP |
| Oct. 20, 2000 08:51 a | 44,675 | CDSG_714.CPP |
| Nov. 16, 1998 09:04 p | 18,172 | CDSG_716.HPP |
| Jan. 21, 1999 05:09 p | 30,403 | CDSG_718.CPP |
| Aug. 20, 1999 11:06 a | 16,780 | CDSG_720.HPP |
| Aug. 24, 1999 04:58 p | 5,593 | CDSG_722.CPP |
| Jul. 9, 1999 04:14 p | 1,821 | CDSG_724.HPP |
| Aug. 24, 1999 04:58 p | 7,316 | CDSG_726.CPP |
| Jul. 9, 1999 04:17 p | 2,216 | CDSG_728.HPP |
| Aug. 24, 1999 04:59 p | 19,778 | CDSG_730.CPP |
| Dec. 3, 1998 03:47 p | 11,642 | CDSG_732.HPP |
| Aug. 24, 1999 04:59 p | 18,973 | CDSG_734.CPP |
| Dec. 3, 1998 03:47 p | 11,802 | CDSG_736.HPP |
| Aug. 24, 1999 05:01 p | 4,798 | CDSG_738.CPP |
| Sep. 28, 1999 10:28 a | 2,324 | CDSG_740.HPP |
| Aug. 24, 1999 05:02 p | 7,863 | CDSG_742.CPP |
| Sep. 28, 1999 10:28 a | 3,056 | CDSG_744.HPP |
| Aug. 24, 1999 05:04 p | 3,604 | CDSG_746.CPP |
| Jul. 9, 1999 04:25 p | 1,410 | CDSG_748.HPP |
| Aug. 24, 1999 05:07 p | 4,377 | CDSG_750.CPP |
| Jul. 9, 1999 04:26 p | 1,719 | CDSG_752.HPP |
| Oct. 20, 2000 08:50 a | 51,664 | CDSG_754.CPP |
| Mar. 16, 2000 04:08 p | 18,220 | CDSG_756.HPP |
| Apr. 17, 2000 10:27 a | 34,518 | CDSG_758.CPP |
| Apr. 17, 2000 10:25 a | 24,679 | CDSG_760.HPP |
| Jan. 7, 2000 09:28 a | 7,561 | CDSG_762.CPP |
| Nov. 3, 1999 11:03 a | 2,346 | CDSG_764.HPP |
| Apr. 28, 2000 05:34 p | 6,111 | CDSG_766.CPP |
| Apr. 28, 2000 05:35 p | 2,617 | CDSG_768.HPP |
| Jun. 29, 2000 03:27 p | 3,715 | CDSG_770.CPP |
| Apr. 8, 1999 05:27 p | 3,704 | CDSG_772.H |
| Feb. 18, 1999 06:19 p | 7,517 | CDSG_774.CPP |
| Feb. 18, 1999 06:19 p | 3,998 | CDSG_776.H |
| Aug. 24, 1999 05:25 p | 35,696 | CDSI_778.CPP |
| Aug. 24, 1999 05:26 p | 8,338 | CDSK_780.CPP |
| Oct. 21, 1998 04:04 p | 2,013 | CDSK_782.HPP |
| Jul. 19, 1999 04:57 p | 26,342 | CDSLIST.CPP |
| Jun. 2, 1999 02:01 p | 9,329 | CDSLIST.H |
| Aug. 25, 1999 01:33 p | 22,780 | CDSLOGIN.CPP |
| Feb. 17, 1999 10:29 a | 3,539 | CDSLOGIN.HPP |
| Aug. 25, 1999 01:25 p | 6,276 | CDSL_788.CPP |
| Dec. 3, 1998 04:47 p | 1,163 | CDSL_790.HPP |
| Aug. 25, 1999 01:26 p | 4,210 | CDSL_792.CPP |
| Aug. 13, 1999 10:53 a | 2,658 | CDSL_794.HPP |
| Aug. 25, 1999 12:33 p | 9,856 | CDSL_800.CPP |
| Nov. 2, 1998 02:26 p | 3,821 | CDSL_802.H |
| Mar. 15, 1999 03:28 p | 3,131 | CDSL_804.HPP |
| Mar. 26, 1999 02:50 p | 4,996 | CDSL_806.CPP |
| Nov. 2, 1998 02:25 p | 2,381 | CDSL_808.H |
| Mar. 15, 1999 05:12 p | 1,319 | CDSL_810.HPP |
| Apr. 28, 2000 05:27 p | 14,874 | CDSL_812.CPP |
| Sep. 25, 1998 07:56 a | 1,110 | CDSL_814.HPP |
| Aug. 25, 1999 02:03 p | 2,668 | CDSL_816.CPP |
| Mar. 16, 1999 10:21 a | 1,140 | CDSL_818.HPP |
| Aug. 25, 1999 02:14 p | 1,864 | CDSL_820.CPP |
| Mar. 26, 1999 02:50 p | 2,860 | CDSL_822.CPP |
| Mar. 30, 2000 06:46 p | 11,409 | CDSM_824.H |
| Aug. 25, 1999 02:17 p | 11,019 | CDSN_826.CPP |
| Jan. 20, 1999 03:26 p | 6,064 | CDSN_828.H |
| May 19, 1999 05:21 p | 9,361 | CDSN_830.CPP |
| Apr. 16, 1999 04:39 p | 14,582 | CDSP_832.CPP |
| Jul. 21, 1999 03:36 p | 6,609 | CDSP_834.H |
| May 26, 1999 01:02 p | 3,482 | CDSP_836.CPP |
| May 26, 1999 01:02 p | 6,545 | CDSP_838.H |
| Dec. 10, 1998 12:53 p | 7,610 | CDSP_840.CPP |
| Dec. 11, 1998 05:42 p | 2,876 | CDSP_842.H |
| May 27, 1999 03:57 p | 2,681 | CDSP_844.CPP |
| May 27, 1999 03:57 p | 4,219 | CDSP_846.H |
| Aug. 25, 1999 02:52 p | 4,903 | CDSP_848.CPP |
| Jul. 12, 1999 09:57 a | 1,508 | CDSP_850.HPP |
| Aug. 25, 1999 02:54 p | 2,980 | CDSP_852.CPP |
| Aug. 10, 1999 11:44 a | 2,891 | CDSP_854.HPP |
| Aug. 25, 1999 02:57 p | 15,338 | CDSR_856.CPP |
| Aug. 25, 1999 03:00 p | 20,860 | CDSR_858.CPP |
| Aug. 25, 1999 04:53 p | 5,377 | CDSR_860.CPP |
| May 20, 1999 04:05 p | 943 | CDSR_862.HPP |
| Aug. 25, 1999 04:54 p | 3,390 | CDSR_864.CPP |
| Aug. 20, 1999 01:33 p | 1,947 | CDSR_866.HPP |
| Jun. 29, 2000 03:26 p | 2,633 | CDSS_868.CPP |
| Apr. 8, 1999 05:48 p | 2,476 | CDSS_870.H |
| Jan. 26, 1999 11:22 a | 18,725 | CDSS_872.HPP |
| Oct. 20, 2000 08:51 a | 52,306 | CDSS_874.CPP |
| Apr. 17, 2000 10:26 a | 25,054 | CDSS_876.HPP |
| Apr. 17, 2000 10:27 a | 35,119 | CDSS_878.CPP |
| Aug. 25, 1999 05:02 p | 3,306 | CDSS_880.CPP |
| Mar. 16, 1999 03:47 p | 1,118 | CDSS_882.HPP |
| Aug. 25, 1999 05:06 p | 3,491 | CDSS_884.CPP |
| Mar. 16, 1999 05:28 p | 1,220 | CDSS_886.HPP |
| Jan. 31, 2001 03:40 p | 20,425 | CDSS_888.CPP |
| Jun. 30, 2000 01:26 p | 251 | CDSS_890.DEF |
| Aug. 30, 2000 05:14 p | 18,553 | CDSS_892.DSP |
| May 24, 2000 12:30 p | 4,561 | CDSS_894.H |
| Jul. 3, 2000 12:12 p | 440 | CDSS_896.IDL |
| Aug. 7, 2000 10:01 p | 7,201 | CDSS_898.RC |
| Jul. 3, 2000 12:15 p | 181 | CDSS_900.RGS |
| Jun. 30, 2000 11:09 a | 10,198 | CDSS_902.CPP |
| Aug. 25, 1999 05:13 p | 3,354 | CDSS_904.CPP |
| Jul. 12, 1999 09:59 a | 1,188 | CDSS_906.HPP |
| Aug. 25, 1999 05:45 p | 24,355 | CDSS_908.CPP |
| Aug. 25, 1999 05:46 p | 15,463 | CDSU_910.CPP |
| Jul. 12, 1999 10:05 a | 4,719 | CDSU_912.HPP |
| Aug. 25, 1999 05:47 p | 3,171 | CDSU_914.CPP |
| Aug. 10, 1999 11:46 a | 2,914 | CDSU_916.HPP |
| Aug. 25, 1999 05:49 p | 6,363 | CDSU_918.CPP |
| Jul. 12, 1999 10:10 a | 3,486 | CDSU_920.HPP |
| Aug. 25, 1999 05:50 p | 3,871 | CDSU_922.CPP |
| Jul. 12, 1999 10:30 a | 2,223 | CDSU_924.HPP |
| Aug. 25, 1999 05:51 p | 6,574 | CDSU_926.CPP |
| Sep. 28, 1999 10:28 a | 3,124 | CDSU_928.HPP |
| Aug. 25, 1999 05:53 p | 3,523 | CDSU_930.CPP |
| Aug. 10, 1999 11:52 a | 3,088 | CDSU_932.HPP |
| Aug. 26, 1999 03:45 p | 5,814 | CDSU_934.CPP |
| Sep. 28, 1999 10:28 a | 3,232 | CDSU_936.HPP |
| Aug. 26, 1999 03:46 p | 3,602 | CDSU_938.CPP |
| Jul. 12, 1999 10:35 a | 1,930 | CDSU_940.HPP |
| Aug. 26, 1999 03:48 p | 11,035 | CDSU_942.CPP |
| Sep. 28, 1999 10:28 a | 3,346 | CDSU_944.HPP |
| Aug. 26, 1999 03:48 p | 3,153 | CDSU_946.CPP |
| Jul. 30, 1999 02:56 p | 4,074 | CDSU_948.HPP |
| Aug. 26, 1999 03:49 p | 8,359 | CDSU_950.CPP |
| Sep. 28, 1999 10:28 a | 3,685 | CDSU_952.HPP |
| Aug. 26, 1999 03:50 p | 3,095 | CDSU_954.CPP |
| Aug. 19, 1999 04:39 p | 2,880 | CDSU_956.HPP |
| Aug. 26, 1999 03:51 p | 8,343 | CDSU_958.CPP |
| Sep. 28, 1999 10:28 a | 2,682 | CDSU_960.HPP |
| Aug. 26, 1999 03:52 p | 3,540 | CDSU_962.CPP |
| Aug. 20, 1999 12:41 p | 3,156 | CDSU_964.HPP |
| Sep. 10, 1999 09:52 a | 6,555 | CDSU_966.CPP |
| Jul. 12, 1999 10:55 a | 2,801 | CDSU_968.HPP |
| Aug. 26, 1999 03:55 p | 4,068 | CDSU_970.CPP |
| Aug. 20, 1999 03:50 p | 2,694 | CDSU_972.HPP |
| Aug. 26, 1999 03:57 p | 7,283 | CDSU_974.CPP |
| Sep. 28, 1999 10:28 a | 2,404 | CDSU_976.HPP |
| Aug. 26, 1999 03:59 p | 3,722 | CDSU_978.CPP |
| Jul. 12, 1999 11:02 a | 1,481 | CDSU_980.HPP |
| Aug. 26, 1999 04:00 p | 3,595 | CDSU_982.CPP |
| Jul. 12, 1999 11:04 a | 1,548 | CDSU_984.HPP |
| Aug. 26, 1999 04:03 p | 6,561 | CDSU_986.CPP |
| Jul. 12, 1999 11:06 a | 2,068 | CDSU_988.HPP |
| Aug. 26, 1999 04:03 p | 3,462 | CDSU_990.CPP |
| Jul. 12, 1999 11:08 a | 1,558 | CDSU_992.HPP |
| Aug. 26, 1999 03:57 p | 3,790 | CDSU_994.CPP |
| Jul. 12, 1999 11:10 a | 2,112 | CDSU_996.HPP |
| Mar. 26, 1999 09:30 a | 2,582 | CDSU_998.CPP |
| Feb. 1, 1999 03:14 p | 1,793 | CDS_1000.H |
| Aug. 26, 1999 04:07 p | 5,429 | CDS_1002.CPP |
| Jan. 12, 1999 06:16 p | 1,538 | CDS_1004.HPP |
| Jun. 29, 2000 03:26 p | 4,229 | CDS_1006.CPP |
| Feb. 18, 1999 06:19 p | 1,912 | CDS_1008.H |
| Jun. 29, 2000 03:26 p | 4,663 | CDS_1010.CPP |
| Feb. 23, 2000 11:32 a | 2,000 | CDS_1012.H |
| Apr. 26, 1999 02:49 p | 1,250 | CDS_1014.CPP |
| Apr. 26, 1999 02:52 p | 1,538 | CDS_1016.H |
| Sep. 24, 1998 10:14 a | 8,913 | CDS_1018.CPP |
| Sep. 24, 1998 10:14 a | 4,924 | CDS_1020.H |
| May 16, 2000 09:46 p | 9,724 | CDS_1022.CPP |
| May 16, 2000 11:09 p | 4,480 | CDS_1024.H |
| Sep. 24, 1998 11:42 a | 8,416 | CDS_1026.CPP |
| Sep. 24, 1998 10:15 a | 3,607 | CDS_1028.H |
| Jun. 29, 2000 03:48 p | 5,243 | CDS_1030.CPP |
| Jan. 19, 2000 04:46 p | 1,878 | CDS_1032.H |
| Jun. 29, 2000 03:48 p | 4,436 | CDS_1034.CPP |
| May 16, 2000 11:25 p | 2,136 | CDS_1036.H |
| May 28, 1999 10:29 a | 3,042 | CDS_1038.CPP |
| May 13, 1999 10:56 a | 5,618 | CDS_1040.H |
| Feb. 10, 1999 12:24 p | 11,938 | CDS_1042.CPP |
| Sep. 24, 1998 10:16 a | 3,814 | CDS_1044.H |
| Apr. 12, 2000 03:34 p | 36,140 | CDS_1046.HPP |
| Apr. 27, 1998 02:15 p | 28,307 | CHARSET.HTM |
| Nov. 28, 2000 10:48 a | 3,627 | CHECKSUM.CPP |
| Sep. 3, 1999 11:19 a | 1,938 | CHECKSUM.H |
| May 26, 1999 01:38 p | 4,553 | CHG_1054.CPP |
| Sep. 14, 1999 10:03 a | 4,420 | CHG_1056.H |
| Aug. 7, 2000 09:02 p | 6,926 | CIH_1058.H |
| Jun. 1, 1999 11:25 a | 2,420 | CMD_1060.CPP |
| Jun. 1, 1999 11:24 a | 2,644 | CMD_1062.H |
| Jun. 30, 2000 03:07 p | 15,689 | COMMON32.CPP |
| Aug. 30, 2000 03:30 p | 5,948 | COMMON32.DSP |
| Jul. 8, 1999 10:30 a | 1,754 | COMMON32.FMT |
| Jul. 17, 2000 02:53 p | 3,344 | COMMON32.H |
| Jun. 17, 2000 03:46 a | 1,503 | COM_1072.H |
| Apr. 3, 2000 05:06 p | 3,976 | COM_1074.H |
| Jul. 17, 2000 02:51 p | 34,081 | CONFIG.CPP |
| Aug. 30, 2000 05:14 p | 19,004 | CONFIG.DSP |
| Jun. 28, 2000 05:41 p | 10,012 | CONFIG.H |
| Dec. 22, 2000 10:53 a | 104,328 | CONFIG.RC |
| Oct. 29, 1997 03:05 p | 398 | CONFIG.RC2 |
| Sep. 21, 1999 01:53 p | 3,327 | CON_1086.CPP |
| Apr. 26, 1999 02:52 p | 1,755 | CON_1088.H |
| Apr. 16, 1999 05:53 p | 1,347 | CON_1090.HTM |
| May 27, 1999 09:12 a | 38,652 | CON_1092.CPP |
| Apr. 26, 1999 02:55 p | 8,359 | CON_1094.H |
| May 13, 1999 09:33 a | 5,965 | CON_1096.CPP |
| May 13, 1999 09:33 a | 2,297 | CON_1098.H |
| Apr. 26, 1999 02:49 p | 4,801 | CON_1100.CPP |
| May 27, 1999 09:20 a | 4,858 | CON_1102.H |
| Sep. 21, 1999 01:53 p | 10,894 | CON_1104.CPP |
| May 6, 1999 02:26 p | 4,152 | CON_1106.H |
| May 27, 1999 09:30 a | 35,215 | CON_1108.CPP |
| Apr. 30, 1999 12:33 p | 19,289 | CON_1110.H |
| May 27, 1999 09:37 a | 8,886 | CON_1112.CPP |
| Apr. 26, 1999 02:52 p | 6,438 | CON_1114.H |
| Apr. 19, 1999 12:51 p | 1,392 | CON_1116.CPP |
| Apr. 19, 1999 12:51 p | 1,334 | CON_1118.H |
| Jun. 23, 1999 07:53 p | 4,339 | CON_1120.CPP |
| Jun. 16, 1999 12:56 p | 3,524 | CON_1122.H |
| Mar. 11, 1999 05:35 p | 1,013 | CON_1124.HTM |
| Oct. 12, 2000 11:09 a | 3,283 | CON_1126.JAV |
| Mar. 11, 1999 05:37 p | 864 | CON_1128.HTM |
| Mar. 11, 1999 05:37 p | 784 | CON_1130.HTM |
| Jun. 29, 2000 03:48 p | 2,412 | COU_1132.CPP |
| Jun. 30, 2000 11:22 a | 2,615 | COU_1134.H |
| May 27, 1999 04:24 p | 24,892 | CRTDATA.CPP |
| Apr. 26, 1999 07:12 p | 6,357 | CRTDATA.H |
| Sep. 18, 1998 04:30 p | 4,088 | CTRLEXT.CPP |
| Sep. 18, 1998 04:49 p | 6,379 | CTRLEXT.H |
| Sep. 18, 1998 04:51 p | 10,044 | CTRLEXT.INL |
| May 27, 1999 04:24 p | 20,499 | CUR_1146.CPP |
| Apr. 27, 1999 01:01 p | 4,247 | CUR_1148.H |
| Sep. 21, 1999, 01:53 p | 26,860 | DADATA.CPP |
| May 26, 1999 12:25 p | 5,287 | DADATA.H |
| Oct. 4, 2000 01:35 p | 4,238 | DAT_1154.JAV |
| Mar. 1, 2001 03:07 p | 6,215 | DBG_1156.CPP |
| Mar. 1, 2001 01:47 p | 2,643 | DBG_1158.H |
| Jun. 30, 2000 11:09 a | 28,206 | DBM_1160.CPP |
| May 24, 2000 11:05 a | 6,138 | DBM_1162.H |
| Sep. 14, 1999 10:38 a | 10,068 | DDVS.CPP |
| Apr. 26, 1999 02:52 p | 635 | DDVS.H |
| Apr. 12, 2001 10:20 a | 10,084 | DEVINFO.CPP |
| Sep. 3, 1999 11:44 a | 2,573 | DEVINFO.H |
| Jul. 19, 1999 02:45 p | 5,369 | DEV_1168.CPP |
| Jun. 30, 2000 04:20 p | 2,788 | DEV_1170.H |
| May 4, 2000 02:28 p | 2,024 | DHO_1176.CPP |
| May 4, 2000 02:28 p | 1,526 | DHO_1178.H |
| Jul. 17, 2000 02:22 p | 4,735 | DIALOGS.CPP |
| Dec. 18, 1998 05:14 p | 2,914 | DIALOGS.H |
| May 28, 1999 12:39 p | 23,586 | DIRDATA.CPP |
| Apr. 26, 1999 06:15 p | 5,126 | DIRDATA.H |
| May 26, 1999 04:24 p | 5,037 | DIR_1188.CPP |
| May 26, 1999 04:23 p | 6,324 | DIR_1190.H |
| Mar. 21, 2001 02:49 p | 4,343 | DIR_1192.H |
| Aug. 31, 2000 02:17 p | 10,296 | DIR_1194.HTM |
| May 27, 1999 04:21 p | 21,284 | DISKDATA.CPP |
| Apr. 26, 1999 08:19 p | 5,251 | DISKDATA.H |
| Nov. 22, 2000 09:08 a | 1,165 | DLLDATAX.C |
| Nov. 22, 2000 09:08 a | 754 | DLLDATAX.H |
| Nov. 28, 2000 10:48 a | 5,575 | DLLMGR.CPP |
| Sep. 17, 1999 10:50 a | 2,841 | DLLMGR.H |
| Jun. 6, 1999 01:36 a | 8,179 | EBROWSER.CPP |
| Jun. 3, 1999 04:40 p | 2,712 | EBROWSER.H |
| Aug. 30, 2000 04:30 p | 4,475 | EJOURNAL.CPP |
| Dec. 4, 2000 09:55 a | 5,268 | EJOURNAL.DSP |
| Jun. 30, 2000 05:21 p | 1,503 | EJOURNAL.H |
| Aug. 16, 2000 05:44 p | 4,696 | EJOURNAL.RC |
| May 12, 1999 03:38 p | 400 | EJOURNAL.RC2 |
| May 14, 1999 08:59 p | 3,149 | EJSERVER.CPP |
| May 14, 1999 08:07 p | 725 | EJSERVER.H |
| Aug. 30, 2000 04:33 p | 12,530 | EJS_1226.CPP |
| Aug. 30, 2000 04:33 p | 1,690 | EJS_1228.H |
| Aug. 16, 2000 04:08 p | 8,955 | ELO_1230.CPP |
| Aug. 16, 2000 04:08 p | 3,402 | ELO_1232.H |
| Apr. 5, 2000 04:54 p | 14,385 | ENUMPROC.CPP |
| May 17, 1999 05:21 p | 1,888 | ENUMPROC.H |
| Apr. 12, 2001 10:20 a | 9,015 | EVENTLOG.CPP |
| Dec. 4, 2000 10:31 a | 6,537 | EVENTLOG.DSP |
| Nov. 4, 1997 12:36 p | 3,945 | EVENTLOG.H |
| May 11, 1999 02:54 p | 868 | EVENTLOG.HTM |
| Mar. 23, 2001 09:48 a | 22,182 | EVENTLOG.RC |
| Nov. 16, 1998 06:10 p | 400 | EVENTLOG.RC2 |
| Mar. 16, 1999 04:18 p | 14,019 | EVENTRDR.CPP |
| Mar. 16, 1999 04:56 p | 7,116 | EVENTRDR.H |
| Jun. 16, 1999 12:09 p | 7,300 | EVE_1238.CPP |
| Jun. 23, 1999 06:43 p | 3,936 | EVE_1240.H |
| Mar. 7, 2001 12:55 p | 30,153 | EVE_1242.CPP |
| Apr. 18, 2000 04:29 p | 16,481 | EVE_1244.H |
| Feb. 12, 1999 08:36 p | 498 | EVE_1262.HTM |
| Feb. 16, 1999 02:18 p | 885 | EVE_1264.HTM |
| Feb. 12, 1999 08:38 p | 1,534 | EVE_1266.HTM |
| Mar. 11, 1999 05:37 p | 554 | EVE_1268.HTM |
| Jun. 3, 1999 04:14 p | 429 | EVE_1270.HTM |
| Jun. 3, 1999 07:06 p | 1,097 | EVE_1272.HTM |
| Feb. 12, 1999 08:07 p | 1,530 | EVE_1274.HTM |
| Jun. 4, 1999 11:01 a | 1,268 | EVE_1276.HTM |
| Jun. 6, 1999 01:38 a | 362 | EVE_1278.HTM |
| Jun. 3, 1999 04:24 p | 1,530 | EVE_1280.HTM |
| Jun. 4, 1999 11:03 a | 1,096 | EVE_1282.HTM |
| Jun. 23 1999 07:51 p | 16,087 | FAV_1284.CPP |
| Jun. 23, 1999 07:52 p | 9,753 | FAV_1286.H |
| Mar. 11, 1999 05:37 p | 731 | FAV_1288.HTM |
| Jun. 24, 1999 03:22 p | 15,652 | FAV_1290.CPP |
| Jun. 24, 1999 03:22 p | 7,669 | FAV_1292.H |
| Aug. 11, 1998 06:32 p | 621 | FRAME.HTM |
| Aug. 11, 1998 05:43 p | 334 | FRAME2D.HTM |
| Aug. 11, 1998 05:16 p | 340 | FRAME3D.HTM |
| Jul. 26, 2000 02:46 p | 29,918 | GAT_1300.CPP |
| May 26, 1999 12:26 p | 7,523 | GAT_1302.H |
| Mar. 11, 1999 05:37 p | 680 | GAT_1304.HTM |
| Jun. 3, 1999 02:53 p | 1,355 | GAT_1306.CPP |
| Sep. 13, 1999 11:41 a | 2,246 | GAT_1308.H |
| Mar. 11, 1999 05:37 p | 744 | GAT_1310.HTM |
| Jun. 28, 1999 04:07 p | 27,116 | GAT_1312.CPP |
| Jul. 21, 1999 03:39 p | 7,275 | GAT_1314.H |
| Mar. 11, 1999 05:37 p | 1,263 | GAT_1316.HTM |
| Aug. 14, 2000 12:56 p | 36,587 | GAT_1318.CPP |
| Mar. 9, 2001 04:06 p | 39,385 | GAT_1320.H |
| Feb. 15, 1999 01:33 p | 607 | GAT_1322.HTM |
| Dec. 26, 2000 04:12 p | 45,674 | GCIDDATA.CPP |
| May 26, 1999 12:26 p | 7,850 | GCIDDATA.H |
| Dec. 26, 2000 03:26 p | 7,071 | GCI_1324.CPP |
| May 26, 1999 03:17 p | 7,389 | GCI_1326.H |
| May 26, 1999 04:27 p | 4,905 | GCI_1328.CPP |
| May 26, 1999 03:19 p | 5,819 | GCI_1330.H |
| Dec. 26, 2000 03:26 p | 6,649 | GCI_1336.CPP |
| May 26, 1999 03:14 p | 7,087 | GCI_1338.H |
| Jun. 24, 1999 06:07 p | 1,763 | GCONHTML.FMT |
| Aug. 8, 2000 01:14 a | 36,043 | GEB_1342.CPP |
| Apr. 7, 2000 01:42 p | 9,473 | GEB_1344.H |
| May 5, 1999 02:05 p | 2,933 | GEC_1346.CPP |
| Jun. 16, 1999 01:00 p | 3,135 | GEC_1348.H |
| Feb. 2, 1999 06:10 p | 655 | GESERVER.HTM |
| May 27, 1999 09:47 a | 3,899 | GET_1352.CPP |
| Jun. 24, 1999 05:59 p | 1,751 | GEXPHTML.FMT |
| Sep. 22, 2000 10:56 a | 38,719 | GEXPTREE.CPP |
| May 23, 2000 01:26 p | 8,982 | GEXPTREE.H |
| May 12, 2000 12:31 p | 10,299 | GEX_1356.CPP |
| Dec. 4, 2000 10:32 a | 9,723 | GEX_1358.DSP |
| Apr. 5, 2000 04:25 p | 2,764 | GEX_1360.H |
| Aug. 16, 2000 04:12 p | 36,040 | GEX_1362.RC |
| Apr. 13, 1998 04:16 p | 401 | GEX_1364.RC2 |
| Mar. 9, 2001 04:05 p | 106,208 | GEX_1366.CPP |
| Mar. 9, 2001 04:05 p | 11,472 | GEX_1368.H |
| Feb. 22, 2001 03:40 p | 98,006 | GEX_1370.CPP |
| Apr. 17, 2000 12:29 p | 8,834 | GEX_1372.H |
| Jun. 16, 1999 12:42 p | 7,806 | GFX.CPP |
| Jun. 16, 1999 12:41 p | 3,100 | GFX.H |
| Apr. 28, 2000 12:54 p | 9,226 | GHTMLCON.CPP |
| Feb. 2, 1999 05:56 p | 233 | GHTMLCON.DEF |
| Dec. 4, 2000 10:33 a | 11,370 | GHTMLCON.DSP |
| Mar. 16, 1999 04:55 p | 2,214 | GHTMLCON.H |
| Aug. 7, 2000 10:04 p | 10,439 | GHTMLCON.RC |
| Feb. 2, 1999 05:55 p | 400 | GHTMLCON.RC2 |
| Dec. 4, 2000 10:33 a | 3,714 | GVC_1394.DSP |
| Sep. 14, 1999 04:22 p | 2,011 | GVC_1396.FMT |
| May 5, 2000 01:31 p | 1,832 | GVC_1398.H |
| Jan. 3, 2001 09:53 a | 5,754 | GWC_1400.H |
| Aug. 9, 2000 04:03 p | 3,715 | GWMATIP.CPP |
| Dec. 6, 1999 12:37 p | 222 | GWMATIP.DEF |
| Apr. 20, 2001 03:04 p | 14,291 | GWMATIP.DSP |
| Aug. 31, 2000 05:02 p | 2,624 | GWMATIP.IDL |
| Aug. 9, 2000 04:03 p | 3,102 | GWMATIP.RC |
| Dec. 6, 1999 12:37 p | 249 | GWM_1412.DEF |
| Dec. 6, 1999 12:37 p | 454 | GWM_1414.MK |
| Jun. 28, 2000 03:48 p | 3,762 | GWP_1416.CPP |
| Dec. 6, 1999 03:37 p | 244 | GWP_1418.DEF |
| Apr. 20, 2001 03:04 p | 14,501 | GWP_1420.DSP |
| Jul. 3, 2000 11:46 a | 891 | GWP_1422.IDL |
| Dec. 6, 1999 03:37 p | 586 | GWP_1424.MK |
| Aug. 7, 2000 10:04 p | 3,123 | GWP_1426.RC |
| Jun. 28, 2000 03:49 p | 4,028 | GWP_1428.CPP |
| Dec. 6, 1999 03:37 p | 260 | GWP_1430.DEF |
| Apr. 20, 2001 03:04 p | 15,433 | GWP_1432.DSP |
| Jul. 27, 2000 05:10 p | 2,843 | GWP_1434.IDL |
| Dec. 6, 1999 02:05 p | 562 | GWP_1436.MK |
| Dec. 17, 1999 05:09 p | 3,055 | GWP_1438.RC |
| Aug. 18, 2000 01:47 p | 3,514 | GWP_1440.CPP |
| Dec. 6, 1999 02:05 p | 240 | GWP_1442.DEF |
| Apr. 20, 2001 03:04 p | 14,526 | GWP_1444.DSP |
| Jul. 3, 2000 11:47 a | 815 | GWP_1446.IDL |
| Apr. 11, 2000 03:14 p | 538 | GWP_1448.MK |
| Aug. 7, 2000 10:04 p | 3,091 | GWP_1450.RC |
| Dec. 6, 1999 02:05 p | 258 | GWP_1452.DEF |
| Apr. 11, 2000 03:14 p | 236 | GWP_1454.DEF |
| Apr. 11, 2000 03:14 p | 256 | GWP_1456.DEF |
| Jun. 28, 2000 03:56 p | 3,752 | GWVIEWER.CPP |
| Jan. 13, 2000 03:25 p | 224 | GWVIEWER.DEF |
| Dec. 4, 2000 10:43 a | 14,175 | GWVIEWER.DSP |
| Aug. 15, 2000 01:40 p | 3,028 | GWVIEWER.IDL |
| Aug. 7, 2000 10:05 p | 3,047 | GWVIEWER.RC |
| Sep. 22, 2000 02:55 p | 47,501 | GWV_1468.CPP |
| Jan. 13, 2000 03:25 p | 250 | GWV_1470.DEF |
| May 25, 2000 12:30 a | 4,808 | GWV_1472.H |
| Jan. 13, 2000 03:25 p | 466 | GWV_1474.MK |
| May 4, 2000 03:12 p | 620 | GWV_1476.RGS |
| Nov. 4, 1997 03:56 p | 3,314 | HCMALC.H |
| May 18, 1998 05:16 p | 3,709 | HCMDEF.H |
| Aug. 14, 1995 02:19 p | 7,557 | HCPACKDF.H |
| Jul. 18, 2000 01:02 p | 1,733 | HGMGLOB.H |
| Jun. 14, 1999 06:07 p | 4,535 | HISTORY.CPP |
| Jun. 18, 1999 12:47 p | 3,443 | HISTORY.H |
| May 18, 1998 05:51 p | 23,809 | HOPACKET.H |
| Jun. 1, 1999 01:05 p | 2,047 | HOS_1492.HTM |
| Apr. 2, 1996 02:42 p | 157 | HP45.INI |
| Apr. 2, 1996 02:43 p | 157 | HP60.INI |
| Apr. 2, 1996 02:43 p | 157 | HP75.INI |
| Apr. 2, 1996 02:43 p | 157 | HP90.INI |
| Apr. 2, 1996 02:43 p | 182 | HPCLIP.INI |
| Jun. 26, 1996 02:12 p | 166 | HPCLIPA.INI |
| Oct. 31, 1997 04:12 p | 193 | HPCOMPAS.INI |
| Apr. 11, 2001 03:59 p | 32,703 | HPHPRINT.CPP |
| Apr. 11, 2001 01:41 p | 17,930 | HPHPRINT.H |
| Apr. 2, 1996 02:43 p | 171 | HPLF.INI |
| Feb. 26, 1996 03:19 p | 626 | HPM.DEF |
| Apr. 4, 2001 10:56 a | 6,373 | HPM.DSP |
| Apr. 5, 2001 04:05 p | 23,698 | HPM.H |
| Mar. 28, 2001 04:38 p | 18,977 | HPM.RC |
| Apr. 12, 2001 10:08 a | 35,853 | HPMAPP.CPP |
| Apr. 3, 2001 11:10 a | 129,866 | HPMCDOC.CPP |
| Aug. 30, 2000 04:02 p | 24,713 | HPMCDOC.H |
| Dec. 8, 2000 11:33 a | 19,575 | HPMCDVW.CPP |
| Dec. 8, 2000 11:33 a | 8,692 | HPMCDVW.H |
| Apr. 13, 1999 05:31 p | 348 | HPMCFG.HM |
| Apr. 14, 1999 06:54 p | 5,995 | HPMCIVW.CPP |
| Apr. 14, 1999 06:54 p | 5,267 | HPMCIVW.H |
| Apr. 2, 2001 09:21 a | 59,612 | HPMCPVW.CPP |
| Apr. 14, 1999 08:36 p | 14,533 | HPMCPVW.H |
| Feb. 5, 1999 06:42 p | 19,354 | HPMCTVW.CPP |
| Nov. 11, 1998 05:11 p | 8,895 | HPMCTVW.H |
| Feb. 9, 2001 10:49 a | 15,560 | HPM_1538.CPP |
| Dec. 8, 2000 12:36 p | 7,129 | HPM_1540.DSP |
| Sep. 9, 1999 04:49 p | 1,747 | HPM_1542.FMT |
| Dec. 5, 2000 03:43 p | 11,673 | HPM_1544.H |
| Aug. 7, 2000 10:05 p | 34,366 | HPM_1546.RC |
| Jun. 1, 1998 06:50 p | 401 | HPM_1548.RC2 |
| Apr. 3, 2001 02:12 p | 20,771 | HPM_1558.CPP |
| Apr. 3, 2001 10:19 a | 13,982 | HPM_1560.H |
| Apr. 12, 2001 10:15 a | 137,105 | HPOUTPUT.CPP |
| Apr. 9, 2001 02:31 p | 28,261 | HPOUTPUT.H |
| Nov. 28, 2000 10:48 a | 5,356 | HPPACKET.CPP |
| Sep. 14, 1999 11:15 a | 5,683 | HPPACKET.H |
| Mar. 30, 2001 10:56 a | 16,677 | HPSTATUS.CPP |
| Mar. 26, 2001 10:16 a | 1,993 | HPSTATUS.H |
| Aug. 3, 2000 11:01 a | 216 | HPTAIR.INI |
| Oct. 31, 1997 05:14 p | 437 | HPTTS.INI |
| Oct. 31, 2000 11:44 a | 33,073 | HSESSINT.CPP |
| Nov.18, 1999 06:19 p | 20,755 | HSESSINT.H |
| Oct. 31, 1997 03:05 p | 1,888 | HSSCREEN.H |
| Oct. 11, 2000 03:54 p | 3,257 | IDL.DSP |
| Feb. 25, 1999 05:25 p | 7,452 | IMAPI.CPP |
| Feb. 25, 1999 03:13 p | 4,149 | IMAPI.H |
| Feb. 15, 1995 02:11 a | 1,357 | IMPLODE.H |
| Feb. 25, 1999 12:29 p | 3,481 | INDEX.HTM |
| Nov. 10, 1998 05:53 p | 427 | INFO.HTM |
| Feb. 15, 1999 01:29 p | 1,494 | INF_1596.HTM |
| Feb. 15, 1999 01:33 p | 1,504 | INF_1598.HTM |
| Feb. 15, 1999 01:33 p | 1,506 | INF_1600.HTM |
| Feb. 15, 1999 01:33 p | 1,494 | INF_1602.HTM |
| Jun. 3, 1999 01:14 p | 1,569 | INF_1604.HTM |
| May 14, 1999 03:52 p | 2,782 | INF_1606.HTM |
| Feb. 15, 1999 01:33 p | 1,854 | INF_1608.HTM |
| Jun. 3, 1999 12:23 p | 761 | INF_1610.HTM |
| Feb. 15, 1999 01:33 p | 576 | INF_1612.HTM |
| Feb. 15, 1999 01:33 p | 676 | INF_1614.HTM |
| Feb. 15, 1999 01:33 p | 1,724 | INF_1616.HTM |
| Feb. 17, 1999 01:48 a | 500 | INF_1618.HTM |
| Feb. 15, 1999 01:33 p | 526 | INF_1620.HTM |
| Feb. 15, 1999 01:33 p | 644 | INF_1622.HTM |
| Aug. 14, 2000 12:59 p | 11,687 | INOUT.CPP |
| Sep. 14, 1999 10:53 a | 10,002 | INOUT.H |
| Aug. 14, 2000 12:59 p | 4,459 | INS_1628.CPP |
| Apr. 17, 2000 02:10 p | 7,486 | INS_1630.H |
| Jun. 30, 2000 11:07 a | 4,672 | LOGIN.CPP |
| May 24, 2000 12:46 p | 4,267 | LOGIN.H |
| Feb. 5, 1999 05:30 p | 216 | LOGO.HTM |
| Jun. 30, 2000 11:27 a | 96,913 | LOG_1636.CPP |
| May 24, 2000 11:29 a | 12,034 | LOG_1638.H |
| Mar. 11, 1999 05:37 p | 2,124 | LOG_1640.HTM |
| Jul. 26, 2000 02:15 p | 8,148 | LOG_1644.CPP |
| May 27, 1999 09:48 a | 4,744 | LOG_1646.H |
| Jun. 3, 1999 03:04 p | 20,999 | LOG_1648.CPP |
| Jun. 28, 1999 04:00 p | 4,406 | LOG_1650.H |
| May 20, 1999 09:11 a | 6,178 | LOG_1652.CPP |
| May 27, 1999 09:53 a | 5,584 | LOG_1654.H |
| Aug. 27, 1998 02:05 p | 674 | MAIN.HTM |
| Apr. 14, 1999 07:01 p | 22,272 | MAINFRM.CPP |
| Apr. 14, 1999 08:36 p | 11,170 | MAINFRM.H |
| Oct. 19, 2000 11:04 a | 2,702 | MAINWND.CPP |
| Jun. 27, 2000 11:54 p | 1,377 | MAINWND.H |
| Oct. 12, 2000 10:41 a | 5,769 | MAI_1662.JAV |
| Feb. 18, 1999 07:27 p | 1,637 | MAI_1668.HTM |
| Feb. 12, 1999 03:00 p | 1,505 | MAI_1670.HTM |
| Feb. 18, 1999 07:27 p | 1,646 | MAI_1672.HTM |
| Feb. 18, 1999 07:25 p | 1,712 | MAI_1674.HTM |
| Feb. 18, 1999 07:29 p | 1,684 | MAI_1676.HTM |
| Feb. 12, 1999 03:00 p | 1,253 | MAI_1678.HTM |
| Feb. 18, 1999 07:29 p | 1,647 | MAI_1680.HTM |
| Feb. 12, 1999 03:00 p | 1,343 | MAI_1682.HTM |
| Feb. 3, 1998 09:07 a | 924 | MAK_1684.MAK |
| Jan. 19, 1999 06:41 p | 869 | MAK_1686.MAK |
| Feb. 22, 1999 03:58 p | 875 | MAK_1688.MAK |
| Dec. 26, 2000 03:21 p | 11,856 | MASKED.CPP |
| Dec. 26, 2000 03:05 p | 4,084 | MASKED.H |
| Feb. 26, 2001 05:40 p | 4,232 | MESSAGEQ.CPP |
| Feb. 26, 2001 05:24 p | 1,711 | MESSAGEQ.H |
| Mar. 9, 2001 04:05 p | 11,692 | MES_1698.CPP |
| Mar. 9, 2001 04:05 p | 5,113 | MES_1700.H |
| Aug. 14, 2000 12:57 p | 29,903 | MFX.CPP |
| Aug. 14, 1998 04:55 a | 175 | MFX.DEF |
| Dec. 4, 2000 10:44 a | 9,092 | MFX.DSP |
| Apr. 7, 2000 10:21 a | 8,411 | MFX.H |
| Aug. 7, 2000 09:58 p | 3,707 | MFX.RC |
| Aug. 14, 1998 04:55 a | 395 | MFX.RC2 |
| Jan. 8, 1999 02:48 p | 6,790 | MFXANI.CPP |
| Jan. 8, 1999 02:04 p | 5,399 | MFXANI.H |
| May 4, 1999 07:30 p | 12,949 | MFXBAR.CPP |
| May 4, 1999 07:21 p | 4,913 | MFXBAR.H |
| Feb. 17, 1999 12:12 a | 4,659 | MFXCOMBO.CPP |
| Feb. 17, 1999 12:12 a | 3,701 | MFXCOMBO.H |
| Jan. 8, 1999 02:48 p | 3,161 | MFXDC.CPP |
| Jan. 7, 1999 03:03 p | 2,214 | MFXDC.H |
| Jan. 25, 1999 12:41 a | 45,678 | MFXDIB.CPP |
| Jan. 15, 1999 02:55 p | 16,480 | MFXDIB.H |
| Jan. 8, 1999 12:31 p | 9,201 | MFXDIB.INL |
| Sep. 27, 1999 12:45 p | 56,525 | MFXFLAT.CPP |
| Sep. 27, 1999 12:45 p | 24,863 | MFXFLAT.H |
| Jun. 1, 1999 01:18 p | 16,669 | MFXFRAME.CPP |
| Sep. 27, 1999 11:44 a | 12,779 | MFXFRAME.H |
| Sep. 9, 1999 04:32 p | 1,744 | MFXHTML.FMT |
| Jan. 7, 1999 04:35 p | 3,237 | MFXJOB.CPP |
| Jan. 8, 1999 02:01 p | 3,850 | MFXJOB.H |
| Sep. 27, 1999 12:45 p | 67,659 | MFXLIST.CPP |
| Jan. 21, 1999 08:26 p | 30,334 | MFXLIST.H |
| Aug. 18, 1998 03:00 p | 1,514 | MFXMAIN.CPP |
| Sep. 27, 1999 12:45 p | 22,174 | MFXMENU.CPP |
| Sep. 27, 1999 11:48 a | 8,643 | MFXMENU.H |
| Jan. 8, 1999 05:08 p | 2,168 | MFXPRINT.CPP |
| Jan. 21, 1999 08:27 p | 2,501 | MFXPRINT.H |
| Sep. 27, 1999 12:45 p | 44,310 | MFXREORG.CPP |
| Jan. 21, 1999 08:27 p | 13,647 | MFXREORG.H |
| Sep. 27, 1999 12:45 p | 56,744 | MFXSPLIT.CPP |
| Jan. 21, 1999 08:27 p | 29,040 | MFXSPLIT.H |
| Apr. 7, 2000 10:23 a | 12,059 | MFXTRAY.CPP |
| Sep. 23, 1999 02:16 p | 3,916 | MFXTRAY.H |
| Jan. 8, 1999 05:14 p | 8,873 | MFXWHEEL.CPP |
| Jan. 21, 1999 08:28 p | 6,116 | MFXWHEEL.H |
| Dec. 22, 1998 10:04 p | 13,034 | MFX_1726.CPP |
| Dec. 22, 1998 09:46 p | 3,991 | MFX_1728.H |
| Aug. 14, 2000 12:57 p | 8,887 | MFX_1740.CPP |
| Jul. 17, 2000 02:21 p | 5,340 | MFX_1742.H |
| Jan. 8, 1999 12:50 p | 5,094 | MFX_1752.CPP |
| Jan. 21, 1999 08:28 p | 3,144 | MFX_1754.H |
| Sep. 27, 1999 12:45 p | 8,677 | MFX_1772.CPP |
| Jan. 21, 1999 08:27 p | 4,389 | MFX_1774.H |
| Jan. 25, 1999 12:41 a | 9,863 | MFX_1784.CPP |
| Jan. 21, 1999 08:27 p | 4,153 | MFX_1786.H |
| Jan. 27, 1999 07:16 p | 63,857 | MFX_1788.CPP |
| Jan. 27, 1999 07:04 p | 13,571 | MFX_1790.H |
| Jan. 25, 1999 12:41 a | 9,704 | MFX_1792.CPP |
| Jan. 21, 1999 08:27 p | 3,181 | MFX_1794.H |
| Feb. 25, 1999 07:30 p | 22,619 | MFX_1796.CPP |
| Jan. 21, 1999 08:27 p | 4,043 | MFX_1798.H |
| Jan. 14, 1999 04:08 p | 7,912 | MFX_1804.CPP |
| Jan. 21, 1999 08:28 p | 4,962 | MFX_1806.H |
| Jan. 23, 1999 12:51 a | 9,059 | MFX_1808.CPP |
| Jan. 15, 1999 02:42 p | 1,773 | MFX_1810.H |
| Sep. 27, 1999 12:45 p | 24,745 | MFX_1812.CPP |
| Sep. 27, 1999 11:48 a | 11,865 | MFX_1814.H |
| Jan. 23, 1999 12:51 a | 19,481 | MFX_1816.CPP |
| Oct. 6, 1998 02:13 a | 4,273 | MFX_1818.H |
| Jan. 8, 1999 05:14 p | 12,460 | MFX_1820.CPP |
| Oct. 6, 1998 02:45 a | 1,945 | MFX_1822.H |
| Feb. 17, 1999 12:12 a | 4,641 | MFX_1828.CPP |
| Feb. 17, 1999 12:11 a | 3,128 | MFX_1830.H |
| Mar. 23, 2001 02:47 p | 5,662 | MOD_1836.CPP |
| Feb. 10, 2000 02:07 p | 2,459 | MOD_1838.H |
| Mar. 9, 2001 04:04 p | 12,378 | MON_1840.CPP |
| Mar. 9, 2001 04:04 p | 5,173 | MON_1842.H |
| Apr. 26, 1999 02:49 p | 2,688 | MRULIST.CPP |
| Apr. 26, 1999 02:53 p | 1,385 | MRULIST.H |
| Feb. 23, 2001 06:24 p | 2,468 | NTLOG.CPP |
| Mar. 15, 2001 06:45 p | 800 | NTLOG.H |
| Jun. 14, 1999 05:56 p | 19,726 | OPTIONS.CPP |
| Jun. 16, 1999 01:04 p | 12,453 | OPTIONS.H |
| Apr. 11, 2001 07:50 a | 46,593 | PACKBLD.CPP |
| Jul. 18, 2000 12:53 p | 25,275 | PACKBLD.H |
| Aug. 19, 1998 03:02 p | 774 | PAGES2D.HTM |
| Aug. 19, 1998 03:02 p | 774 | PAGES3D.HTM |
| Jun. 14, 1999 05:55 p | 5,684 | PAG_1864.CPP |
| Jun. 16, 1999 01:04 p | 4,726 | PAG_1866.H |
| Sep. 21, 1999 01:54 p | 32,419 | POOLDATA.CPP |
| May 26, 1999 12:26 p | 6,124 | POOLDATA.H |
| May 26, 1999 03:43 p | 12,040 | POO_1868.CPP |
| May 26, 1999 03:53 p | 6,043 | POO_1870.H |
| May 26, 1999 04:27 p | 8,427 | POO_1876.CPP |
| May 26, 1999 04:03 p | 5,842 | POO_1878.H |
| Apr. 26, 1999 02:49 p | 2,939 | POO_1880.CPP |
| Apr. 26, 1999 02:53 p | 3,404 | POO_1882.H |
| Jun. 29, 2000 05:30 p | 7,953 | PRIQUEUE.CPP |
| Jan. 28, 1999 12:16 p | 4,084 | PRIQUEUE.H |
| May 27, 1999 04:23 p | 22,399 | PRI_1884.CPP |
| Apr. 27, 1999 12:27 p | 5,613 | PRI_1886.H |
| Apr. 28, 1999 03:00 p | 15,700 | PRI_1888.CPP |
| Sep. 14, 1999 10:05 a | 11,176 | PRI_1890.H |
| Apr. 28, 1999 04:35 p | 22,234 | PROPDIR.CPP |
| Apr. 28, 1999 04:31 p | 11,383 | PROPDIR.H |
| Apr. 28, 1999 03:07 p | 16,272 | PROPDISK.CPP |
| Apr. 28, 1999 03:23 p | 9,408 | PROPDISK.H |
| Aug. 3, 2000 03:08 p | 6,952 | PRO_1896.CPP |
| Jun. 1, 1999 03:06 p | 1,889 | PRO_1898.H |
| May 28, 1999 10:41 a | 7,353 | PRO_1900.CPP |
| May 28, 1999 10:39 a | 8183 | PRO_1902.H |
| May 28, 1999 10:42 a | 3,534 | PRO_1904.CPP |
| Apr. 26, 1999 02:53 p | 3,449 | PRO_1906.H |
| Apr. 26, 1999 02:50 p | 22,116 | PRO_1908.CPP |
| Sep. 14, 1999 10:09 a | 11,455 | PRO_1910.H |
| Apr. 27, 1999 05:16 p | 3,408 | PRO_1912.CPP |
| Apr. 27, 1999 04:21 p | 3,119 | PRO_1914.H |
| Apr. 26, 1999 02:50 p | 2,787 | PRO_1916.CPP |
| Apr. 26, 1999 02:53 p | 2,050 | PRO_1918.H |
| Apr. 26, 1999 02:50 p | 13,759 | PRO_1920.CPP |
| Apr. 28, 1999 02:43 p | 8,520 | PRO_1922.H |
| Apr. 27, 1999 05:57 p | 3,228 | PRO_1924.CPP |
| Apr. 27, 1999 06:04 p | 3,198 | PRO_1926.H |
| May 28, 1999 12:06 p | 5,378 | PRO_1928.CPP |
| May 28, 1999 10:44 a | 6,475 | PRO_1930.H |
| May 28, 1999 10:46 a | 3,330 | PRO_1932.CPP |
| May 28, 1999 12:00 p | 2,976 | PRO_1934.H |
| Apr. 27, 1999 05:05 p | 2,586 | PRO_1944.CPP |
| Apr. 27, 1999 04:35 p | 2,821 | PRO_1946.H |
| Apr. 26, 1999 02:50 p | 2,864 | PRO_1948.CPP |
| Apr. 26, 1999 02:53 p | 2,057 | PRO_1950.H |
| Apr. 27, 1999 06:00 p | 2,652 | PRO_1952.CPP |
| Apr. 27, 1999 05:26 p | 3,151 | PRO_1954.H |
| Apr. 26, 1999 02:53 p | 2,383 | PRO_1956.H |
| May 28, 1999 10:52 a | 21,931 | PRO_1958.CPP |
| May 28, 1999 10:48 a | 11,434 | PRO_1960.H |
| May 28, 1999 10:59 a | 9,853 | PRO_1962.CPP |
| May 28, 1999 12:01 p | 7,187 | PRO_1964.H |
| Dec. 26, 2000 03:07 p | 10,090 | PRO_1966.CPP |
| May 28, 1999 12:03 p | 7,925 | PRO_1968.H |
| May 28, 1999 11:15 a | 5,470 | PRO_1970.CPP |
| May 28, 1999 12:06 p | 5,922 | PRO_1972.H |
| Dec. 21, 2000 09:50 a | 14,587 | PRO_1974.CPP |
| May 28, 1999 12:06 p | 8,230 | PRO_1976.H |
| May 28, 1999 11:20 a | 3,768 | PRO_1978.CPP |
| Apr. 26, 1999 02:53 p | 3,953 | PRO_1980.H |
| May 28, 1999 11:22 a | 3,132 | PRO_1982.CPP |
| Sep. 14, 1999 10:06 a | 2,864 | PRO_1984.H |
| May 28, 1999 11:50 a | 11,012 | PRO_1986.CPP |
| May 28, 1999 12:06 p | 6,407 | PRO_1988.H |
| May 28, 1999 11:51 a | 3309 | PRO_1990.CPP |
| Apr. 26, 1999 02:53 p | 3,368 | PRO_1992.H |
| Apr. 26, 1999 02:50 p | 5,373 | PRO_1994.CPP |
| Apr. 26, 1999 02:53 p | 3,113 | PRO_1996.H |
| Apr. 27, 1999 05:31 p | 3,599 | PRO_1998.CPP |
| Apr. 27, 1999 05:49 p | 3,613 | PRO_2000.H |
| Apr. 26, 1999 02:50 p | 31,205 | PRO_2002.CPP |
| Apr. 26, 1999 02:53 p | 11,342 | PRO_2004.H |
| Jun. 3, 1999 03:10 p | 3,232 | PRO_2006.CPP |
| Jun. 3, 1999 03:06 p | 2,877 | PRO_2008.H |
| Aug. 4, 1999 03:28 p | 15,205 | PRPH.H |
| May 3, 1999 03:43 p | 55 | RCS.RC |
| Jun. 28, 2000 01:31 a | 1,677 | RESOURCE.H |
| May 28, 1999 04:15 p | 4,774 | RESULT.HTM |
| Apr. 16, 1999 05:35 p | 596 | RIGHT.HTM |
| Mar. 11, 1999 05:37 p | 1,979 | RIGHTBTM.HTM |
| Feb. 5, 1999 04:30 p | 467 | RIGHTTOP.HTM |
| Jul. 24, 2000 03:11 p | 9,093 | RTMIMPL.H |
| Jul. 31, 2000 04:43 p | 4,774 | SAM_2026.HTM |
| Feb. 17, 1999 05:41 p | 434 | SEA_2028.HTM |
| Mar. 1, 1999 04:49 p | 1,973 | SEA_2030.HTM |
| Feb. 17, 1999 05:44 p | 525 | SEA_2032.HTM |
| Jun. 30, 2000 05:17 p | 5,497 | SER_2034.CPP |
| Apr. 5, 2000 10:48 a | 1,651 | SER_2036.H |
| Nov. 6, 2000 05:07 p | 4,268 | SES_2038.JAV |
| Jun. 30, 2000 10:31 a | 1,087 | SHU_2040.CPP |
| Jun. 30, 2000 11:22 a | 1,270 | SHU_2042.H |
| Jul. 19, 1999 04:57 p | 94,341 | SOCKET.CPP |
| Jun. 21, 1999 06:46 p | 28,328 | SOCKET.H |
| Sep. 1, 2000 02:45 p | 8,488 | SOC_2048.CPP |
| Sep. 1, 2000 02:40 p | 1,636 | SOC_2050.H |
| Jul. 19, 1999 03:49 p | 14,317 | SOC_2052.CPP |
| Jun. 3, 1999 12:15 p | 5,284 | SOC_2054.H |
| Jul. 19, 1999 04:50 p | 42,358 | SOC_2056.CPP |
| May 20, 1999 07:52 p | 10,249 | SOC_2058.H |
| Mar. 29, 1998 10:03 p | 7,362 | SPE_2060.HTM |
| May 27, 1999 12:13 p | 4,003 | SPL_2062.CPP |
| May 27, 1999 12:14 p | 3,524 | SPL_2064.H |
| Jun. 28, 2000 05:43 p | 8,362 | SPL_2066.CPP |
| May 12, 1999 09:23 a | 12,637 | SPL_2068.H |
| Feb. 5, 1999 05:55 p | 8,588 | SPL_2070.CPP |
| Feb. 5, 1999 10:52 a | 4,626 | SPL_2072.H |
| Aug. 7, 2000 09:58 p | 26,508 | STATUS.RC |
| Aug. 30, 2000 05:15 p | 4,097 | STA_2076.DSP |
| Oct. 12, 2000 10:44 a | 1,875 | STA_2078.JAV |
| Oct. 14, 1999 09:48 p | 315 | STDAFX.CPP |
| Apr. 3, 2001 05:41 p | 1,486 | STDAFX.H |
| Mar. 5, 2001 10:46 a | 17,030 | SWGW.CPP |
| Jan. 24, 2001 02:11 p | 12,097 | SWGW.DSP |
| Jul. 3, 2000 12:12 p | 415 | SWGW.IDL |
| Aug. 7, 2000 09:57 p | 3,768 | SWGW.RC |
| Jun. 21, 2000 01:23 a | 171 | SWGW.RGS |
| Oct. 11, 2000 05:11 p | 4,138 | SWGWMAIN.CPP |
| Dec. 8, 1999 07:07 p | 224 | SWGWMAIN.DEF |
| Apr. 20, 2001 03:04 p | 16,056 | SWGWMAIN.DSP |
| Feb. 16, 2001 12:07 p | 10,903 | SWGWMAIN.IDL |
| Aug. 7, 2000 10:06 p | 3,386 | SWGWMAIN.RC |
| Jun. 21, 2000 01:16 a | 246 | SWGWPS.DEF |
| Jun. 21, 2000 01:16 a | 418 | SWGWPS.MK |
| Jul. 20, 2000 11:05 a | 581 | SWG_2094.XML |
| Dec. 8, 1999 07:01 p | 250 | SWG_2106.DEF |
| Dec. 8, 1999 07:01 p | 466 | SWG_2108.MK |
| Aug. 7, 2000 02:48 p | 2,053 | TABLE.CPP |
| Jul. 31, 2000 10:59 a | 701 | TABLE.H |
| Mar. 26, 1999 02:47 p | 20,335 | TAB_2114.CPP |
| Mar. 23, 1998 09:26 p | 2,738 | TAB_2116.H |
| Aug. 13, 1998 06:43 p | 2,999 | TAB_2122.HTM |
| Jul. 2, 1998 03:31 p | 902 | TAB_2124.HTM |
| Jun. 29, 2000 05:30 p | 21,721 | TBL_2126.CPP |
| May 24, 2000 01:06 p | 2,931 | TBL_2128.H |
| Jun. 22, 2000 08:57 p | 8,509 | TCP_2130.CPP |
| Apr. 17, 2000 12:32 p | 1,532 | TCP_2132.H |
| Jun. 8, 1998 03:49 p | 882 | TEAM.HTM |
| Aug. 7, 2000 10:42 p | 19,069 | TEDIT.CPP |
| Aug. 7, 2000 10:36 p | 3,548 | TEDIT.H |
| Apr. 16, 1999 03:31 p | 189 | TERMINAL.HTM |
| May 30, 2000 12:45 p | 2,015 | TES_2142.HTM |
| Apr. 14, 2000 02:01 p | 1,728 | TES_2144.HTM |
| Jun. 29, 2000 05:25 p | 16,266 | THRDHDLR.H |
| Jun. 30, 2000 11:08 a | 181,312 | THR_2148.CPP |
| Jun. 30, 2000 11:09 a | 6,231 | TIM_2150.CPP |
| Jan. 12, 1999 02:20 p | 729 | TIM_2152.H |
| Sep. 15, 1997 05:48 p | 5,792 | TRACEWIN.H |
| Jul. 27, 2000 05:28 p | 4,618 | TRA_2156.CPP |
| Jul. 27, 2000 05:26 p | 3,222 | TRA_2158.H |
| Jul. 19, 1999 04:51 p | 32,591 | TRA_2160.CPP |
| Jul. 19, 1999 04:14 p | 8,775 | TRA_2162.H |
| Jul. 19, 1999 03:47 p | 10,336 | TRA_2164.CPP |
| Apr. 15, 1999 02:12 p | 4,757 | TRA_2166.H |
| Jul. 19, 1999 04:49 p | 72,909 | TRA_2168.CPP |
| Jul. 21, 1999 03:27 p | 14,248 | TRA_2170.H |
| Feb. 12, 1999 08:42 p | 762 | TREE.HTM |
| Apr. 28, 2000 12:55 p | 381 | TREE_GD.HTM |
| Apr. 28, 2000 12:56 p | 382 | TREE_GWD.HTM |
| Apr. 28, 2000 12:56 p | 379 | TREE_WD.HTM |
| Feb. 5, 1999 04:34 p | 2,158 | TRE_2174.HTM |
| Apr. 4, 2000 02:49 p | 542 | TSTRING.H |
| Aug. 13, 1998 06:43 p | 718 | URLTEST.HTM |
| May 21, 1999 04:14 p | 33,413 | USERSPG.CPP |
| Jul. 21, 1999 03:39 p | 7,363 | USERSPG.H |
| May 11, 1999 05:35 p | 19,730 | USE_2186.CPP |
| Apr. 22, 1999 04:41 p | 4,666 | USE_2188.H |
| Jun. 30, 2000 03:02 p | 1,162 | VAL_2194.CPP |
| Jul. 27, 2000 12:56 p | 7,352 | VAL_2196.H |
| Apr. 21, 1999 03:11 p | 5,625 | VCU_2198.H |
| Apr. 21, 1999 03:11 p | 4,057 | VCU_2200.H |
| Apr. 21, 1999 03:11 p | 2,575 | VCU_2202.H |
| Mar. 11, 1999 04:49 p | 1,750 | VER_2204.HTM |
| Feb. 15, 1999 01:18 p | 857 | VIEW.HTM |
| Feb. 15, 1999 01:32 p | 278 | VIE_2208.HTM |
| Feb. 18, 1999 07:19 p | 618 | VIE_2210.HTM |
| Sep. 13, 1999 12:54 p | 2,294 | VIS_2212.HTM |
| Mar. 11, 1999 05:37 p | 3,711 | WELCOME.HTM |
| Jul. 26, 1998 05:51 p | 1,123 | WIZ_2216.CPP |
| Jul. 25, 1998 11:14 p | 1,488 | WIZ_2218.H |
| May 27, 1999 08:31 a | 8,422 | WIZ_2220.CPP |
| May 27, 1999 03:19 p | 8,372 | WIZ_2222.H |
| May 27, 1999 03:09 p | 4,869 | WIZ_2224.CPP |
| May 27, 1999 03:07 p | 5,632 | WIZ_2226.H |
| May 27, 1999 09:33 a | 5,649 | WIZ_2228.CPP |
| May 27, 1999 09:34 a | 6,828 | WIZ_2230.H |
| May 27, 1999 08:46 a | 7,428 | WIZ_2232.CPP |
| May 27, 1999 08:38 a | 4,158 | WIZ_2234.H |
| Sep. 21, 1999 01:54 p | 14,455 | WIZ_2236.CPP |
| May 27, 1999 09:27 a | 14,496 | WIZ_2238.H |
| Apr. 29, 1999 10:26 a | 6,657 | WIZ_2240.CPP |
| Apr. 29, 1999 11:39 a | 9,236 | WIZ_2242.H |
| Apr. 28, 1999 05:36 p | 17,984 | WIZ_2244.CPP |
| Apr. 28, 1999 05:42 p | 11,515 | WIZ_2246.H |
| Apr. 26, 1999 02:50 p | 2,900 | WIZ_2248.CPP |
| Apr. 26, 1999 02:54 p | 2,518 | WIZ_2250.H |
| Jun. 3, 1999 07:19 p | 50,293 | WIZ_2252.CPP |
| Jun. 3, 1999 05:18 p | 14,209 | WIZ_2254.H |
| Apr. 26, 1999 02:50 p | 17,482 | WIZ_2256.CPP |
| Apr. 28, 1999 04:04 p | 11,148 | WIZ_2258.H |
| Apr. 26, 1999 02:50 p | 2,798 | WIZ_2260.CPP |
| Apr. 26, 1999 02:54 p | 2,398 | WIZ_2262.H |
| Apr. 26, 1999 02:50 p | 12,221 | WIZ_2264.CPP |
| Apr. 26, 1999 02:54 p | 8,270 | WIZ_2266.H |
| Apr. 26, 1999 02:50 p | 2,826 | WIZ_2268.CPP |
| Apr. 26, 1999 02:54 p | 2,395 | WIZ_2270.H |
| May 27, 1999 03:38 p | 6,636 | WIZ_2272.CPP |
| May 27, 1999 03:37 p | 3,679 | WIZ_2274.H |
| Dec. 21, 2000 09:50 a | 25,505 | WIZ_2276.CPP |
| May 27, 1999 03:19 p | 7,875 | WIZ_2278.H |
| May 28, 1999 12:49 p | 3,663 | WIZ_2280.CPP |
| May 28, 1999 12:49 p | 2,871 | WIZ_2282.H |
| Jun. 3, 1999 09:19 p | 15,099 | WIZ_2284.CPP |
| Jun. 3, 1999 09:22 p | 4,921 | WIZ_2286.H |
| Apr. 26, 1999 02:50 p | 3,769 | WIZ_2288.CPP |
| Apr. 26, 1999 02:54 p | 2,517 | WIZ_2290.H |
| May 28, 1999 12:57 p | 3,591 | WIZ_2292.CPP |
| May 28, 1999 12:57 p | 2,909 | WIZ_2294.H |
| May 28, 1999 10:10 a | 11,625 | WIZ_2296.CPP |
| May 28, 1999 10:21 a | 5,782 | WIZ_2298.H |
| Jun. 3, 1999 07:28 p | 24,907 | WIZ_2300.CPP |
| May 27, 1999 03:19 p | 8,324 | WIZ_2302.H |
| Apr. 26, 1999 02:50 p | 12,640 | WIZ_2304.CPP |
| Apr. 26, 1999 02:54 p | 9,492 | WIZ_2306.H |
| Apr. 26, 1999 02:50 p | 2,904 | WIZ_2308.CPP |
| Apr. 26, 1999 02:54 p | 2,461 | WIZ_2310.H |
| Jun. 3, 1999 04:58 p | 15,698 | WIZ_2312.CPP |
| Jun. 3, 1999 04:15 p | 5,617 | WIZ_2314.H |
| Jun. 3, 1999 08:48 p | 54,881 | WIZ_2316.CPP |
| Jun. 3, 1999 08:18 p | 11,996 | WIZ_2318.H |
| Jun. 3, 1999 05:13 p | 19,859 | WIZ_2320.CPP |
| Jun. 3, 1999 04:28 p | 5,408 | WIZ_2322.H |
| Apr. 11, 2001 04:31 p | 28,228 | WIZ_2324.CPP |
| Dec. 26, 2000 11:56 a | 8,605 | WIZ_2326.H |
| Apr. 26, 1999 02:50 p | 15,788 | WIZ_2328.CPP |
| Apr. 26, 1999 02:54 p | 4,082 | WIZ_2330.H |
| Mar. 3, 1999 02:30 p | 1,841 | WIZ_2332.CPP |
| Mar. 3, 1999 01:19 p | 1,372 | WIZ_2334.H |
| Jun. 3, 1999 03:56 p | 10,778 | WIZ_2336.CPP |
| Apr. 30, 1999 03:25 p | 5,742 | WIZ_2338.H |
| Apr. 12, 2001 10:19 a | 14,536 | WKCFMNGR.CPP |
| Jul. 18, 2000 01:04 p | 7,069 | WKCFMNGR.H |
| Apr. 11, 2001 07:33 a | 34,357 | WMMSG.CPP |
| Jul. 18, 2000 12:54 p | 24,146 | WMMSG.H |
| Oct. 11, 2000 05:48 p | 2,457 | WOR_2348.JAV |
| Jun. 14, 1999 06:01 p | 4,488 | WOR_2350.CPP |
| Jun. 16, 1999 01:04 p | 3,771 | WOR_2352.H |
| Jul. 28, 2000 01:51 p | 47,045 | WOR_2354.CPP |
| Apr. 26, 1999 02:54 p | 7,834 | WOR_2356.H |
| Dec. 1, 2000 11:18 a | 712 | WOR_2358.RGS |
| Feb. 13, 2001 01:46 p | 7,777 | WOR_2360.CPP |
| Dec. 1, 2000 12:11 p | 2,087 | WOR_2362.H |
| Apr. 12, 2001 10:16 a | 12,877 | WSABTBOX.CPP |
| Aug. 24, 1999 11:14 a | 8,192 | WSABTBOX.H |
| Aug. 7, 2000 10:45 p | 7,467 | WSAPISTS.CPP |
| Aug. 7, 2000 09:13 p | 4,283 | WSAPISTS.H |
| Apr. 11, 2001 07:35 a | 20,532 | WSATB2.CPP |
| Sep. 16, 1999 10:35 a | 10,619 | WSATB2.H |
| Aug. 10, 2000 04:13 p | 5,147 | WSA_2364.CPP |
| Jun. 28, 2000 01:30 a | 1,904 | WSA_2366.H |
| Sep. 13, 1999 04:22 p | 5,028 | WSA_2368.HPP |
| Jun. 27, 2000 11:26 p | 643 | WSA_2370.RGS |
| Jun. 30, 2000 03:01 p | 8,980 | WSA_2372.CPP |
| Apr. 5, 2001 02:09 p | 57,936 | WSBAG.CPP |
| Apr. 2, 2001 03:33 p | 12,875 | WSBAG.H |
| Sep. 13 1999 01:34 p | 204,080 | WSBAG.HPP |
| May 3, 2000 05:13 p | 572 | WSBAG.RGS |
| Jun. 30, 2000 02:57 p | 3,307 | WSBUFFER.CPP |
| Jul. 19, 1999 04:10 p | 1,906 | WSBUFFER.H |
| May 6, 1999 12:47 p | 5,417 | WSB_2394.H |
| Mar. 7, 2000 02:59 p | 3,377 | WSB_2396.H |
| Apr. 4, 2001 01:49 p | 19,315 | WSB_2398.H |
| Oct. 11, 2000 02:52 p | 4,477 | WSCITEST.CPP |
| Apr. 12, 2001 03:04 p | 4,804 | WSCITEST.DSP |
| Apr. 27, 2000 12:38 p | 1,463 | WSCITEST.H |
| Mar. 22, 2000 11:00 a | 412 | WSCITEST.IDL |
| Apr. 12, 2001 01:32 p | 8,146 | WSCITEST.RC |
| Mar. 22, 2000 11:00 a | 400 | WSCITEST.RC2 |
| Mar. 22, 2000 11:00 a | 179 | WSCITEST.RGS |
| Dec. 5, 2000 01:51 p | 4,321 | WSCLIENT.CPP |
| May 2, 2000 07:54 a | 224 | WSCLIENT.DEF |
| Apr. 20, 2001 03:04 p | 16,005 | WSCLIENT.DSP |
| Dec. 12, 2000 09:11 a | 11,598 | WSCLIENT.IDL |
| Oct. 11, 2000 04:40 p | 3,535 | WSCLIENT.RC |
| Jul. 17, 2000 11:45 a | 3,776 | WSCONFIG.CPP |
| Jan. 5, 2000 04:13 p | 224 | WSCONFIG.DEF |
| Aug. 30, 2000 05:14 p | 14,841 | WSCONFIG.DSP |
| Jun. 27, 2000 01:44 p | 1,801 | WSCONFIG.IDL |
| Aug. 7, 2000 10:07 p | 3,130 | WSCONFIG.RC |
| Apr. 11, 2001 07:50 a | 25,999 | WSCOPROC.CPP |
| Aug. 4, 1999 03:24 p | 21,314 | WSCOPROC.H |
| Apr. 5, 2001 02:06 p | 11,554 | WSC_2404.CPP |
| Apr. 19, 2001 10:30 a | 3,062 | WSC_2406.H |
| May 4, 2000 01:22 p | 652 | WSC_2408.RGS |
| Apr. 13, 2001 09:12 a | 26,154 | WSC_2424.CPP |
| Apr. 12, 2001 01:32 p | 3,575 | WSC_2426.H |
| Aug. 9, 2000 01:05 p | 3,213 | WSC_2428.H |
| Mar. 1, 1999 01:57 p | 919 | WSC_2430.H |
| Aug. 29, 2000 04:14 p | 16,584 | WSC_2442.CPP |
| May 2, 2000 07:54 a | 250 | WSC_2444.DEF |
| May 2, 2000 08:48 a | 2,041 | WSC_2446.H |
| Oct. 26, 2000 01:54 p | 2,132 | WSC_2448.IDL |
| May 2, 2000 07:54 a | 466 | WSC_2450.MK |
| Jul. 3, 2000 11:36 a | 700 | WSC_2452.RGS |
| Aug. 29, 2000 04:14 p | 2,461 | WSC_2454.H |
| Oct. 27, 2000 09:37 a | 4,361 | WSC_2456.H |
| Aug. 10, 2000 04:57 p | 10,867 | WSC_2458.CPP |
| Apr. 24, 2000 10:21 a | 1,794 | WSC_2460.H |
| Jun. 30, 2000 03:17 p | 2,783 | WSC_2462.HPP |
| May 3, 2000 05:15 p | 667 | WSC_2464.RGS |
| Aug. 22, 2000 05:35 p | 11,247 | WSC_2466.H |
| Sep. 21, 2000 03:41 p | 26,268 | WSC_2478.CPP |
| Jan. 5, 2000 04:13 p | 250 | WSC_2480.DEF |
| Jun. 24, 2000 05:15 a | 2,062 | WSC_2482.H |
| Jan. 5, 2000 04:13 p | 466 | WSC_2484.MK |
| Jun. 22, 2000 04:21 p | 700 | WSC_2486.RGS |
| Oct. 10, 2000 08:20 a | 2,561 | WSC_2488.CPP |
| Feb. 5, 2001 11:32 a | 8,087 | WSC_2490.H |
| May 24, 2000 04:20 p | 683 | WSC_2492.RGS |
| Feb. 13, 2001 10:37 a | 66,753 | WSC_2494.CPP |
| Aug. 1, 2000 03:13 a | 4,790 | WSC_2496.H |
| May 4, 2000 11:04 a | 715 | WSC_2498.RGS |
| Apr. 24, 2001 01:21 p | 11,196 | WSC_2500.CPP |
| Mar. 19, 2001 05:36 p | 2,288 | WSC_2502.H |
| Feb. 23, 1999 11:05 a | 5,124 | WSDEBUG.HPP |
| Apr. 24, 2001 03:48 p | 10,249 | WSDEVICE.CPP |
| Dec. 5, 2000 05:19 p | 3,971 | WSDEVICE.H |
| May 4, 2000 11:04 a | 627 | WSDEVICE.RGS |
| Apr. 11, 2001 07:50 a | 21,137 | WSDIAGS.CPP |
| Sep. 16, 1999 11:39 a | 10,183 | WSDIAGS.H |
| Jul. 17, 2000 11:54 a | 7,688 | WSDLLAPP.CPP |
| Jun. 22, 1999 10:55 a | 3,983 | WSDLLAPP.H |
| Jun. 30, 2000 03:01 p | 7,104 | WSDLLMGR.CPP |
| Sep. 24, 1999 07:18 p | 4,605 | WSDLLMGR.HPP |
| Nov. 6, 1996 12:46 p | 7,518 | WSERRDEF.H |
| Apr. 15, 2000 04:07 p | 14,246 | WSEVENT.CPP |
| Oct. 20, 1998 02:56 p | 10,864 | WSEVENT.H |
| Oct. 20, 1998 02:56 p | 10,715 | WSEVENT.HPP |
| Jul. 17, 2000 11:53 a | 34,006 | WSEVLOG.CPP |
| Jun. 22, 1999 10:49 a | 15,115 | WSEVLOG.H |
| Jul. 17, 2000 11:24 a | 18,165 | WSEVNTLG.CPP |
| Jul. 3, 2000 10:53 a | 15,840 | WSEVNTLG.HPP |
| Jun. 22, 1999 11:06 a | 37,997 | WSEVTLG.CPP |
| Jun. 22, 1999 11:06 a | 11,151 | WSEVTLG.H |
| Jun. 22, 1999 10:42 a | 4,931 | WSEVTLID.H |
| Mar. 30, 2001 02:34 p | 16,734 | WSE_2536.CPP |
| Mar. 30, 2001 02:34 p | 6,308 | WSE_2538.H |
| May 3, 2000 05:14 p | 612 | WSE_2540.RGS |
| Mar. 30, 2000 05:51 p | 1,449 | WSE_2542.H |
| Aug. 18, 2000 01:50 p | 14,182 | WSE_2544.H |
| Jun. 6, 1999 12:54 a | 8,700 | WSE_2546.H |
| Mar. 23, 2001 03:04 p | 10,633 | WSE_2562.CPP |
| Mar. 23, 2001 11:57 a | 1,638 | WSE_2564.H |
| Sep. 18, 2000 11:52 a | 19,110 | WSE_2566.H |
| Apr. 12, 2001 10:08 a | 31,852 | WSFILEIO.CPP |
| Dec. 22, 1999 04:37 p | 18,283 | WSFILEIO.H |
| Apr. 13, 2001 01:07 p | 11,224 | WSGCID.CPP |
| Mar. 1, 2001 04:45 p | 3,495 | WSGCID.H |
| May 4, 2000 01:22 p | 759 | WSGCID.RGS |
| Apr. 28, 1994 02:14 p | 2,785 | WSGLOB.H |
| Feb. 26, 2001 12:30 p | 20,043 | WSG_2572.CPP |
| Feb. 16, 2001 12:09 p | 3,258 | WSG_2574.H |
| May 4, 2000 01:21 p | 604 | WSG_2576.RGS |
| Mar. 22, 2001 05:03 p | 2,020 | WSG_2584.H |
| Aug. 15, 2000 02:05 p | 30,014 | WSH_2588.CPP |
| Aug. 15, 2000 02:06 p | 8,835 | WSH_2590.H |
| Jul. 3, 2000 11:40 a | 692 | WSH_2592.RGS |
| Apr. 24, 2001 02:47 p | 26,622 | WSH_2594.CPP |
| Apr. 24, 2001 01:44 p | 7,022 | WSH_2596.H |
| Jul. 19, 2000 11:01 a | 850 | WSH_2598.RGS |
| Dec. 6, 2000 05:00 p | 3,975 | WSH_2600.CPP |
| Feb. 2, 2001 04:49 p | 1,565 | WSH_2602.H |
| May 30, 2000 12:52 p | 731 | WSH_2604.RGS |
| Dec. 12, 2000 09:41 a | 8,667 | WSH_2606.CPP |
| Dec. 12, 2000 09:41 a | 3,048 | WSH_2608.H |
| Jun. 26, 2000 03:07 p | 3,260 | WSH_2610.H |
| Apr. 11, 2001 07:52 a | 4,503 | WSH_2612.CPP |
| Nov. 9, 1999 04:48 p | 1,076 | WSH_2614.H |
| Jun. 22, 1999 10:38 a | 4,287 | WSINFO.H |
| Jun. 28, 2000 05:08 p | 40,228 | WSINIFIL.CPP |
| Jun. 22, 1999 10:38 a | 16,312 | WSINIFIL.H |
| Aug. 19, 1999 04:42 p | 5,130 | WSINTFAC.H |
| Jan. 25, 2001 04:56 p | 3,521 | WSI_2622.CPP |
| Nov. 22, 2000 09:08 a | 226 | WSI_2624.DEF |
| Jan. 25, 2001 04:59 p | 14,690 | WSI_2626.DSP |
| Feb. 18, 2001 12:43 a | 5,012 | WSI_2628.IDL |
| Nov. 22, 2000 09:08 a | 478 | WSI_2630.MK |
| Dec. 6, 2000 10:49 a | 3,102 | WSI_2632.RC |
| Feb. 18, 2001 12:46 a | 11,610 | WSI_2634.VBS |
| Nov. 22, 2000 09:08 a | 251 | WSI_2636.DEF |
| Mar. 22, 2001 05:05 p | 7,666 | WSI_2640.CPP |
| Oct. 12, 2000 02:08 p | 2,550 | WSI_2642.H |
| Aug. 3, 2000 01:02 p | 636 | WSI_2644.RGS |
| Dec. 5, 2000 01:53 p | 5,621 | WSI_2646.CPP |
| Aug. 3, 2000 04:01 p | 1,532 | WSI_2648.H |
| Aug. 3, 2000 01:02 p | 652 | WSI_2650.RGS |
| Jul. 26, 2000 03:57 p | 12,810 | WSLOCK.CPP |
| Apr. 24, 2000 12:53 p | 2,387 | WSLOCK.H |
| Sep. 27, 1999 10:02 a | 15,797 | WSLOCK.HPP |
| May 3, 2000 05:13 p | 580 | WSLOCK.RGS |
| Nov. 30, 1999 07:20 p | 2,008 | WSL_2660.H |
| Jan. 2, 2001 05:03 p | 34,739 | WSMATIP.CPP |
| Sep. 1, 2000 12:12 p | 4,670 | WSMATIP.H |
| Jul. 3, 2000 11:28 a | 583 | WSMATIP.RGS |
| Apr. 11, 2001 07:50 a | 34,710 | WSMODIFY.CPP |
| Jul. 18, 2000 12:56 p | 11,837 | WSMODIFY.H |
| Jul. 18, 2000 12:54 p | 6,000 | WSMSGDEF.H |
| Oct. 17, 2000 01:50 p | 16,563 | WSM_2668.CPP |
| Jul. 27, 2000 01:28 p | 9,816 | WSM_2670.H |
| Aug. 31, 2000 04:46 p | 607 | WSM_2672.RGS |
| Mar. 22, 2001 11:29 a | 20,154 | WSM_2674.H |
| Aug. 31, 2000 01:11 p | 1,970 | WSM_2676.H |
| Jun. 22, 2000 10:53 a | 683 | WSM_2682.RGS |
| Apr. 19, 2001 03:01 p | 10,138 | WSM_2684.CPP |
| Apr. 13, 2001 01:24 p | 2,256 | WSM_2686.H |
| Jul. 3, 2000 11:44 a | 666 | WSM_2688.RGS |
| Aug. 22, 2000 01:31 p | 2,881 | WSO_2692.CPP |
| Apr. 24, 2000 10:36 a | 1,238 | WSO_2694.H |
| Jun. 22, 2000 10:54 a | 939 | WSO_2696.RGS |
| Jul. 18, 2000 12:52 p | 29,746 | WSPANAPI.H |
| Apr. 10, 2001 08:59 a | 28,090 | WSPORT.CPP |
| Feb. 12, 2001 03:49 p | 14,179 | WSPORT.H |
| Apr. 26, 1999 01:54 p | 3,554 | WSP_2700.H |
| Jun. 30, 2000 03:01 p | 12,128 | WSP_2702.CPP |
| May 18, 1999 05:05 a | 4,631 | WSP_2704.HPP |
| Aug. 29, 2000 04:15 p | 938 | WSP_2710.H |
| Oct. 25, 1999 05:01 p | 2,294 | WSQUEUE.CPP |
| Oct. 25, 1999 04:57 p | 1,776 | WSQUEUE.H |
| Jan. 22, 1999 04:55 p | 4,100 | WSQUEUE.HPP |
| May 3, 2000 05:10 p | 588 | WSQUEUE.RGS |
| Jun. 30, 2000 03:01 p | 114,519 | WSREGACS.CPP |
| Jun. 22, 1999 11:53 a | 58,943 | WSREGACS.HPP |
| Jul. 17, 2000 11:54 a | 127,612 | WSREGAPP.CPP |
| Jun. 22, 1999 10:32 a | 41,426 | WSREGAPP.H |
| Jul. 17, 2000 11:56 a | 65,005 | WSREGTRY.CPP |
| Jun. 22, 1999 10:25 a | 25,645 | WSREGTRY.H |
| Jun. 30, 2000 03:08 p | 112,176 | WSR_2728.CPP |
| Sep. 13, 1999 04:26 p | 54,671 | WSR_2730.HPP |
| Mar. 23, 2001 02:51 p | 9,317 | WSR_2732.CPP |
| Jul. 26, 2000 01:28 p | 1,633 | WSR_2734.H |
| May 3, 2000 05:13 p | 610 | WSR_2736.RGS |
| Jun. 10, 2000 05:07 a | 7,230 | WSR_2742.CPP |
| Apr. 24, 2000 10:39 a | 19,583 | WSR_2744.H |
| Jul. 3, 2000 11:40 a | 684 | WSR_2746.RGS |
| Apr. 13, 2001 09:41 a | 49,317 | WSSOCKET.CPP |
| Aug. 31, 2000 04:35 p | 3,842 | WSSOCKET.H |
| May 3, 2000 05:14 p | 596 | WSSOCKET.RGS |
| May 7, 1999 04:12 p | 6,046 | WSSOCKRC.HPP |
| Apr. 21, 1995 03:14 p | 1,085 | WSSTDERR.H |
| Mar. 22, 2001 05:04 p | 5,485 | WSS_2748.CPP |
| Oct. 12, 2000 02:09 p | 1,801 | WSS_2750.H |
| Jun. 13, 2000 11:05 a | 1,583 | WSS_2752.IDL |
| May 4, 2000 01:22 p | 604 | WSS_2754.RGS |
| Jun. 13, 2000 02:26 p | 51 | WSS_2756.CPP |
| Apr. 20, 2001 07:14 a | 10,576 | WSS_2758.H |
| May 4, 2000, 01:22 p | 660 | WSS_2760.RGS |
| Apr. 6, 2001 10:48 a | 143,849 | WSS_2762.CPP |
| Mar. 22, 2001 11:45 a | 11,316 | WSS_2764.H |
| Aug. 15, 2000 02:17 p | 17,569 | WSS_2766.H |
| Aug. 7, 2000 11:29 a | 18,396 | WSS_2768.H |
| Mar. 15, 2001 09:47 a | 8,240 | WSS_2770.CPP |
| Aug. 31, 2000 04:37 p | 2,392 | WSS_2772.H |
| May 3, 2000 05:15 p | 715 | WSS_2774.RGS |
| Aug. 8, 2000 05:00 p | 4,997 | WSS_2784.CPP |
| Mar. 31, 2000 07:44 p | 8,519 | WSS_2786.H |
| Jun. 13, 2000 01:21 p | 652 | WSS_2788.RGS |
| Feb. 21, 2001 11:03 a | 2,349 | WSS_2790.H |
| Aug. 8, 2000 05:02 p | 1,558 | WSS_2792.H |
| Feb. 28, 2001 09:34 a | 4,400 | WSS_2794.H |
| Feb. 26, 2001 06:22 p | 5,675 | WSS_2798.CPP |
| Apr. 24, 2000 10:26 a | 1,097 | WSS_2800.H |
| May 3, 2000 05:14 p | 628 | WSS_2802.RGS |
| Jul. 17, 2000 11:54 a | 88,319 | WSTOOLS.CPP |
| May 4, 1999 08:40 p | 1,072 | WSTOOLS.DEF |
| Aug. 30, 2000 05:14 p | 6,744 | WSTOOLS.DSP |
| Jul. 17, 2000 11:31 a | 62,120 | WSTOOLS.H |
| Aug. 7, 2000 10:07 p | 4,755 | WSTOOLS.RC |
| Oct. 11, 2000 05:09 p | 2,922 | WSTOOLS2.CPP |
| Oct. 14, 1999 09:48 p | 224 | WSTOOLS2.DEF |
| Apr. 20, 2001 03:04 p | 19,990 | WSTOOLS2.DSP |
| Apr. 11, 2001 04:01 p | 24,185 | WSTOOLS2.IDL |
| Mar. 16, 2001 04:13 p | 5,507 | WSTOOLS2.RC |
| Oct. 17, 2000 02:38 p | 5,291 | WST_2804.H |
| May 2, 2000 09:29 p | 4,680 | WST_2806.CPP |
| May 2, 2000 09:27 p | 2,161 | WST_2808.H |
| May 3, 2000 05:14 p | 620 | WST_2810.RGS |
| Oct. 14, 1999 09:48 p | 250 | WST_2832.DEF |
| Oct. 14, 1999 09:48 p | 466 | WST_2834.MK |
| Feb. 23, 2001 05:36 p | 5,500 | WST_2836.CPP |
| Jul. 27, 2000 05:11 p | 2,043 | WST_2838.H |
| Jul. 3, 2000 11:40 a | 668 | WST_2840.RGS |
| Apr. 13, 2001 10:01 a | 53,976 | WSUTILS.CPP |
| Feb. 18, 2001 12:43 a | 4,702 | WSUTILS.H |
| Nov. 27, 2000 01:38 p | 624 | WSUTILS.RGS |
| Apr. 11, 2001 07:50 a | 14,639 | WSWINDRV.CPP |
| Jul. 18, 2000 12:57 p | 9,409 | WSWINDRV.H |
| Jun. 30, 2000 03:01 p | 68,479 | WSWNSOCK.CPP |
| Jan. 6, 1999 11:41 a | 23,975 | WSWNSOCK.HPP |
| Mar. 14, 2001 04:57 p | 5,721 | WSX_2856.H |
| May 14, 1999 12:31 p | 7,525 | WWATB.H |
| Jun. 9, 1998 11:03 p | 19 | XML.CPP |
| Aug. 14, 1998 05:06 a | 175 | XML.DEF |
| Dec. 4, 2000 10:48 a | 6,334 | XML.DSP |
| Aug. 14, 1998 06:10 a | 668 | XML.H |
| Mar. 16, 1999 04:47 p | 9,221 | XML.INL |
| Aug. 7, 2000 09:56 p | 4,001 | XML.RC |
| Aug. 14, 1998 05:06 a | 395 | XML.RC2 |
| Mar. 16, 1999 04:48 p | 3,809 | XMLBAG.CPP |
| Mar. 16, 1999 04:49 p | 4,004 | XMLBAG.H |
| Sep. 27, 1999 01:16 p | 1,815 | XMLHTML.FMT |
| Aug. 14, 1998 05:06 a | 1,512 | XMLMAIN.CPP |
| Mar. 16, 1999 04:40 p | 25,949 | XMLTABLE.CPP |
| Mar. 16, 1999 04:48 p | 20,058 | XMLTABLE.H |
| Sep. 27, 1999 01:11 p | 81,590 | XMLTAGS.CPP |
| Mar. 16, 1999 04:48 p | 39,555 | XMLTAGS.H |
| Sep. 27, 1999 01:09 p | 80,836 | XMLUTIL.CPP |
| Mar. 16, 1999 04:48 p | 12,982 | XMLUTIL.H |
| Sep. 27, 1999 01:13 p | 40,620 | XML_2878.CPP |
| Jun. 3, 1999 05:27 p | 14,720 | XML_2880.H |
| Mar. 16, 1999 04:40 p | 10,706 | XML_2882.CPP |
| Mar. 15, 1999 07:27 p | 9,942 | XML_2884.CPP |
| Jun. 3, 1999 06:53 p | 36,856 | XML_2886.CPP |
| Jun. 3, 1999 06:53 p | 14,865 | XML_2888.H |
| Oct. 2, 1998 07:24 p | 308 | XML_2890.HTM |
| Sep. 27, 1999 12:53 p | 9,979 | XML_2894.H |
| Mar. 16, 1999 04:40 p | 24,897 | XML_2906.CPP |
| Mar. 16, 1999 04:48 p | 7,463 | XML_2908.H |
| Apr. 24, 2000 04:27 p | 3,141 | XTL_2914.H |
| Feb. 26, 2001 05:51 p | 10,580 | XTL_2916.H |
| Jul. 27, 2000 12:35 p | 6,588 | XTL_2918.H |
| Feb. 25, 1999 08:03 p | 20,599 | ZIPFILE.CPP |
| Feb. 25, 1999 08:03 p | 5,980 | ZIPFILE.H |

### BACKGROUND OF THE INVENTION

1. Field of the Invention

The present invention relates to gateways operable to interface one network, system, or application with another. More particularly, the invention relates to an enterprise software gateway operable to facilitate client access to a legacy host system by transparently performing protocol conversion and managing large volumes of transactional messages and large structured data messages.

2. Description of the Prior Art

A gateway is an OSI (Open System Interconnection) layer 4 interface between networks, systems, or applications. In this capacity, gateways may, though not necessarily, perform protocol conversion, such as might be required between a legacy host system and one or more client systems. A gateway may also be used to manage transactional and structured messages between host and client systems.

A gateway may be called upon to handle different types of client applications in their interaction with the host, including standalone applications normally implemented on individual workstations and each requiring its own gateway connection, and server-based applications normally distributed over one or more servers and requiring multiple connections. Standalone applications tend to generate a low number of transacted messages per workstation. When implemented in a multiple workstation configuration, however, collective message volume can be significant. Server-based applications typically generate a large number of transactional messages and large-sized structured data messages. Because of the size of these structured data messages, and TPF (transaction processing facility) block size limitations, the messages are broken into smaller segments for transmission. The client applications then require a message queuing ability to provide guaranteed delivery of each message segment and a method of properly reassembling the segments into the original message structure.

For example, a centralized legacy host system may be used for processing travel transactions by travel agents. In a typical travel agency there may be many agents using personal computers (PC) running client (Terminal Emulation) programs requesting and receiving information from the host system. A single gateway establishes a communications connection with the host, and, using an agreed upon messaging protocol, transmits and receives all client/host messages across the single communications link. Thus, gateways provide a number of benefits, including cost savings by eliminating the need to support a communications link between the host system and every client device in every agency location.

Another benefit of having a single communications link is a simplified set of development tools for accessing the host. Setting up and managing a communications link to the host is a complicated process requiring a high degree of technical expertise and understanding, particularly of messaging protocols. Fortunately for developers, APIs (application programming interfaces) are provided to access the gateway, and the gateway transparently handles the complexities of communicating with the host system.

Another benefit of the gateway is that existing client applications are protected from any changes in how a connection to the host is established. Over time, with adoption of new and improved technologies, procedures for establishing a connection change, including changes in messaging protocols. Without a gateway performing protocol conversion, these changes would directly affect every application; with a gateway, however, the applications are unaffected so long as the APIs are not changed.

For all the benefits associated with gateways, however, existing gateways typically suffer from a number of disadvantages resulting from limitations in capacity, ability, and performance. For example, existing gateways restrict the number of different operating systems on which client applications can be implemented, and dictate the implementation location of the applications by requiring that client applications be implemented on the same physical local area network (LAN) as the gateway. Furthermore, existing gateways have limited and cryptic diagnostic and support ability and tools, thereby hampering technical support and troubleshooting efforts.

Due to the above-described and other problems in the art, a need exists for an improved gateway.

### SUMMARY OF THE INVENTION

The present invention solves the above-described and other problems and provides a distinct advance in the art of gateway interfaces. More specifically, the present invention is an enterprise software gateway operable to interface and facilitate client access to a legacy host system by transparently performing protocol conversion and effectively managing large volumes of transactional messages from multiple stand-alone applications and large structured data messages from single or multiple server-based applications. The gateway includes a viewer operable to allow remote monitoring of interactions, including communication, between the host and client, and to allow remote control of the gateway's functionality, thereby facilitating problem diagnosis and troubleshooting. Thus, the viewer provides a support mechanism for remotely viewing event logs, monitoring realtime message flows, or gathering statistical information, as well as remotely diagnosing and configuring the gateway using TCP/IP.

The gateway is implemented in an enterprise configuration, meaning that it can operate at a different physical location from the client application and can support multiple client sites. Communication between client applications and the gateway is available through any private or public network running TCP/IP, including an extranet, an intranet, or the Internet.

The gateway provides client applications with multiple communication interfaces, with no restrictions on client operating system. To ensure maximum availability, the gateway is able to run as a service on a Windows 32 bit operating system (e.g., Windows NT or Windows 2000), providing immediate availability after a hardware reboot. A TCP/IP socket interface provides the lowest common connectivity to the gateway. Microsoft Component Object Model provides a simplified interface for Windows-based development. There are no limitations to the number of connections to the gateway other than those present within the system resources of the hardware or operating system.

The gateway includes a DIR (data interface record) queuing protocol for reconstructing messages, and is able to handle multiple messages, including DIR messages, concurrently. Furthermore, the gateway itself is a multi-threaded application, capable of running in a multi-processor environment and managing 32-bit multi-threaded applications.

Other advantages of the present invention over the prior art include a high volume message queuing capability for delivering and re-packaging mainframe data delimited records; integrated management of the gateway through standard operating system tools; and ability to control access to the gateway via the operating system according to a predefined authorization scheme.

The present invention has application to web services requiring a remote gateway, including terminal emulators and host printing across the Internet, Internet booking engines, travel agency desktop applications (particularly where an onsite gateway is desirable), and as a business object server gateway where host connectivity is required.

These and other novel features of the present invention are described in more detail in the section titled DETAILED DESCRIPTION OF A PREFERRED EMBODIMENT, below.

### BRIEF DESCRIPTION OF THE DRAWING FIGURES

The present invention is described in detail below with reference to the attached drawing figures, wherein:

FIG. 1 is a block diagram showing relationships between various hardware components in an exemplary embodiment of a system with which a preferred embodiment of the present invention may be used;

FIG. 2 is a flowchart showing relationships between major components of a Gateway Viewer portion of a preferred embodiment of the present invention;

FIG. 3 is a screen capture showing in detail a preferred embodiment of a Welcome Window component of the embodiment shown in FIG. 2;

FIG. 4 is a screen capture showing in detail a preferred embodiment of a Gateway Window component of the embodiment shown in FIG. 2;

FIG. 5 is a screen capture of a preferred first drop down menu component of the embodiments shown in FIGS. 2 and 3;

FIG. 6 is a screen capture of a preferred second drop down menu component of the embodiments shown in FIGS. 2 and 3;

FIG. 7 is a screen capture of a preferred first pop-up menu component and preferred first tabbed-menu component of the embodiments shown in FIGS. 2 and 3;

FIG. 8 is a screen capture of a preferred first pop-up menu component and preferred second tabbed-menu component of the embodiment shown in FIG. 7;

FIG. 9 is a screen capture of a preferred first pop-up menu component and preferred third tabbed-menu component of the embodiment shown in FIG. 7;

FIG. 10 is a screen capture of a preferred third drop down menu component of the embodiments shown in FIGS. 2 and 3;

FIG. 11 is a screen capture of a preferred fourth drop down menu component of the embodiments shown in FIGS. 2 and 3;

FIG. 12 is an exemplary first information display provided by the embodiment shown in FIG. 4;

FIG. 13 is an exemplary second information display provided by the embodiment shown in FIG. 4;

FIG. 14 is an exemplary third information display provided by the embodiment shown in FIG. 4; and

FIG. 15 is an exemplary fourth information display provided by the embodiment shown in FIG. 4.

### DETAILED DESCRIPTION OF A PREFERRED EMBODIMENT

The present invention is an enterprise software gateway operable to facilitate, by transparently performing protocol conversion and managing communication, access to and interaction between a host system, such as a mainframe legacy system, and client application or device, including software applications and input/output (I/O) devices. A viewer is provided operable to monitor and report interactions, including communication between the host and client, and to allow for remote configuration and control of the gateway's functionality, thereby facilitating problem diagnosis and solution.

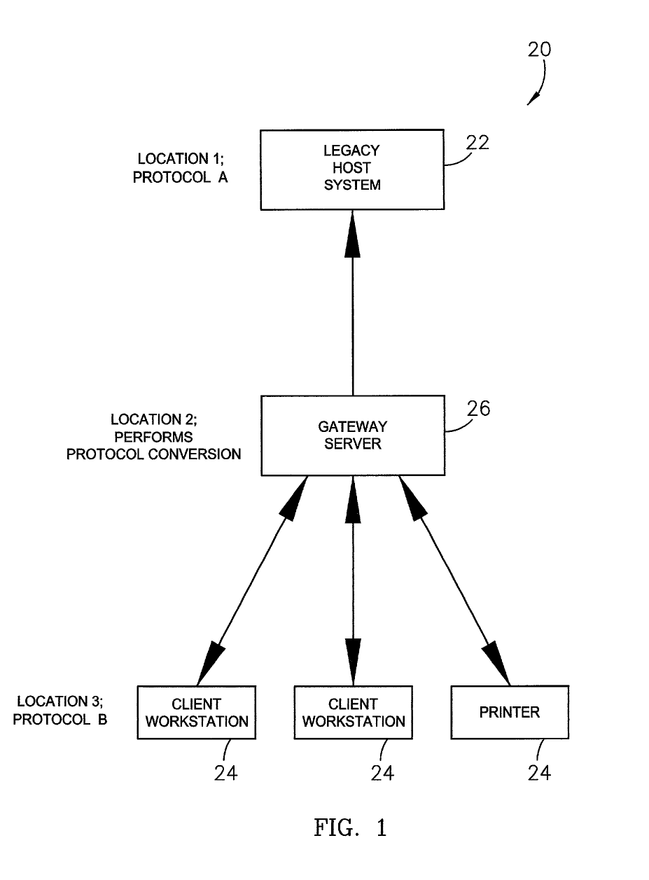

Referring to FIG. 1, a system 20 is shown with which the present invention may be used, and broadly comprising a host system 22; a plurality of client devices 24; and a gateway server 26. The host system 22 may be a conventional legacy mainframe or other centralized or distributed system to which clients interface over a network in a manner requiring protocol conversion or data and message management.

The client devices 24 may be any conventional computing devices, including networks, systems, and peripheral equipment such as printers or CRTs, and connectable to a network for communication through the gateway server 26 to the host system 22 in the context of a client application. The client devices 24 may each employ any of variety of different operating systems which support a TCP/IP socket interface.

The gateway server 26 may be any conventional computing device, such as a server, operable to store and execute the enterprise software gateway and connect to a network. The gateway server 26 may be locally or remotely located relative to the host system 22 or client devices 24. The software gateway is operable to support, and the gateway server 26 should provide, connections for a number of different remotely or locally located client devices, preferably including a TCP/IP socket interface. The TCP/IP socket interface, along with a standard protocol and language, allows any operating system and programming language to interface with the gateway.

The enterprise software gateway preferably comprises a combination of program code segments operable to perform the functions described herein. A preferred embodiment of the enterprise software gateway program is appended hereto as a computer listing appendix. Though shown, in the system described above, as being stored upon and executed by the gateway server 26, the software gateway may alternatively be executed by the client devices 24, and stored on any computer readable memory media, including magnetic or optical, forming a part of the executing device, such as a hard disk drive, or other wise accessible thereto, such as a floppy disk or CD-ROM. Furthermore, the code segments of the software gateway may be written in any suitable programming language executable by the executing device, including Assembly, C++, or Java.

The enterprise software gateway is operable to establish logical connections between the host system 22 and the client devices 24. The connections are achieved using a client interface based upon the Component Object Model and comprising several classes, including IWSDevice, IWSConfiguredDevices, IWSHostSession, IWSHostSessionDispatch, and IWSSessionCallback.

IWSDevice is operable to store information about an individual client device 26, creating one object for each device 26 configured for the client application. The interface of this object, IWSDevice, supports the following properties, including:

| | |
|---|---|
| Gateway | the specific gateway FQDN used by the |
| | requested IWSDevice; |
| DeviceType | the specific device type of the requested |
| | IWSDevice object; |
| Poolname | the pool name of the individual IWSDevice |
| | object; |
| Port | the port (e.g., COM1, COM2, LPT1) stored |
| | for the individual IWSDevice object; |
| Outputfile | the filename stored for the individual |
| | IWSDevice object if the device type (i.e., |
| | Interface-Disk Intl., Interface-Disk U.S., |
| | FastClip) writes to a file on the disk; the |
| | filename is used to write host printer |
| | applications; |
| DeviceDescriptor | the filename (i.e., HP45.INI, HP6O.INI, |
| | HPCLP.INI, HPCLP.INI) used to define |
| | information necessary to use a particular |
| | printer; used for host printer applications; |
| CommunicationsParameters | the parameters (i.e., Baud, Parity, Databits, |
| | Stopbits, Timeout) configured in the CDS |
| | database for a particular printer; used for |
| | host printer applications; |
| GetAIIGCIDDAs | all GCIDs and DAs associated with the |
| | IWSDevice formatted as a string of hexa- |
| | decimal values; |
| GetAIIGCIDDAsX | all GCIDs and DAs associated with the |
| | IWSDevice formatted as an XML string. |

IWSConfiguredDevices is operable to return the number of device types stored for the client application. The client application creates this interface only if it needs knowledge about a pool. It is necessary, for example, to create IWSConfiguredDevices to determine the device type of a printer. This object is implemented as a container class and may be safely used as such by Visual Basic and scripting clients. The interface to this object, IWSConfiguredDevices, supports the following properties:

| | |
|---|---|
| Count | returns the number of IWSDevice objects created and stored |
| | in this container (one IWSDevice object is created for each |
| | device type (e.g., CRT, DIR, Printer-ATB. Printer- |
| | Hardcopy, Interface-Disk U.S.) Configured for the |
| | workstation); |
| Item | returns the pointer to a specific IWSDevice object; |
| _NewEnum | returns an enumerator for Visual Basic applications. |

IWSHostSession is operable to send host messages to the host system 22. This interface, being based on the IUnknown interface, is especially suited for C++ client applications. The interface to this object, IWSHostSession, supports the following functions:

| | |
|---|---|
| Initialize | provides the client application's name, sets the Device Type |
| | to be used for the particular host session and passes the |
| | address to the Callback object to be used for host responses; |
| InitializeEx | provides the client application's name, sets the Pool Name |
| | to be used for the particular host session, and passes the |
| | address to the Callback object to be used for host responses; |
| Open | opens the particular host session; |
| Close | closes the particular host session; |
| Send | sends data to the host; |
| QueryStatus | retrieves the last status returned from the host; |
| Device | retrieves the pointer to the IWSDevice object for the |
| | current session; |
| GCIDDA | retrieves the GCID and DA associated with the current |
| | session; |
| AckPrintMsg | sends an acknowledgment to the host for each data block |
| | received; |

IWSHostSessionDispatch is operable to send host messages to the host system 22, and is based upon the IDispatch interface. This interface is especially suited for Visual Basic or Visual Basic Script, but can be used by all client devices 26. The interface to this object, IWSHostSessionDispatch, supports the following functions:

| | |
|---|---|
| Initialize | provides the Client Application name and sets the Device |
| | Type to be used for the particular host session; |
| InitializeEx | provides the Client Application name and sets the Pool |
| | Name to be used for the particular host session; |
| Open | opens the particular host session; |
| Close | closes the particular host session; |
| Send | sends data to the host; |
| QueryStatus | retrieves the last status returned from the host; |
| Device | retrieves the pointer to the IWSDevice object for the current |
| | session; |
| GCIDDA | retrieves the GCID and DA associated with the current |
| | session; |
| AckPrintMsg | sends an acknowledgment to the host for each data block |
| | received; |

IWSSessionCallback is an interface used by C++ applications to receive messages and statuses from the gateway. The client application must provide an object that implements this interface. Visual Basic and scripting clients use a standard event handling mechanism to receive statuses and data from the gateway. The functions defined by this interface include:

| | |
|---|---|
| OnStatus | used by the client application to receive changes in host, |
| | session, or gateway status and error conditions; also used |
| | by clients implementing message queuing to manage DIR |
| | messages and unsolicited messages from the host; |
| OnReceive | used by the client application to receive host responses. |

The connections between the host system 22 and client devices 24 are also achieved using a socket interface. The gateway server 26 listens at port 4000 for incoming socket connections. When the client application opens the connection to the software gateway, the software gateway sends a Challenge Message to the client application for authentication. Upon receipt of the Challenge Message, the client application returns a Challenge Response to the software gateway.

In addition to the Challenge Response, the client application must pass to the software gateway the application name, pool name, and workstation fully qualified domain name as the requesting application. This information must be previously constructed for the client application and must match a configuration stored in the CDS server for the software gateway.

The software gateway sends a Challenge Acceptance in response to a successful Challenge Response, or a Challenge Refusal in response to an invalid Challenge Response. The Challenge Refusal is also returned if the client device configuration does not exist or is incorrect. The GCID value, Device Address and Device Type of the client device 24 are returned to the client application as part of a Challenge Acceptance. Once connected, the client application is operable to send and receive host entries and responses until such time that the client application closes the socket session.

The software gateway is also operable to restrict user access according to a predetermined authentication scheme, with authentication information possibly being stored on a remotely or locally located authentication server. Related to security, the software gateway is also operable to provide one or more packet encoding schemas to protect data integrity by restricting a user's ability to change information being communicated between the host system 22 and gateway server 26 or between the client device 24 and gateway server 26.

The enterprise software gateway also provides a filtering ability operable to allow clients to selectively intercept for examination information communicated by the host system 22.

The enterprise software gateway includes a DIR queuing protocol for reconstructing messages that have been broken into pieces to facilitate transmission, and is able to handle multiple messages, including DIR messages, concurrently. Furthermore, the gateway itself is a multi-threaded application, capable of running in a multi-processor environment and managing 32-bit multi-threaded applications. The software gateway also provides a high volume message queuing capability for delivering and re-packaging mainframe data delimited records.

In operation, the client creates an instance of IWSConfiguredDevices which may retrieve a list of pools defined for the workstation or other client device 24 the object is created on. This latter operation is optional, but may be used to pre-determine the number and nature of devices and pools available to the client application. The client application uses this object as a COM container by iterating contents through it and inspecting the properties of each IWSDevice it contains.

If the client is a C++ client supplying an object implementing the IWSSessionCallback interface, then the client creates an instance of IWSHostSession. If, however, the client is a Visual Basic or scripting client or a C++ client implementing COM events, then the client creates an instance of IWSHostSessionDispatch.

As part of the object initialization process, a copy of IWSConfiguredDevices is created by this object for its internal use, upon successful completion of which the client application performs a number of steps. First, the client application calls Initialize to create a host session based upon a device type. Alternatively, the application calls InitializeEx to create a host session based upon the pool of devices. The client application then calls Open to prepare the host session for transmitting gateway and host requests. Next, the application calls Send to transmit gateway and host requests. If IWSSessionCallback is used, responses to the Send function are sent to the client application via the IWSSessionCallback interface. If IWSSessionCallback is not used, the standard event handling mechanism, as defined by Visual Basic and scripting, is used to transmit responses and statuses to the client application. Lastly, the application calls Close to end the host session.

The gateway provides a gateway viewer to operable to facilitate monitoring of interactions, particularly communications, traffic between the host system 22 and the client system 26, including creating, viewing, and saving event logs containing information related to communication errors, warnings, success events, events occurring, and status. The viewer is also operable to facilitate remote control and configuration of the gateway. Using the viewer, authorized personnel, such as technical support personnel, are able to remotely connect to the gateway by identifying the FQDN or IP address of the desired gateway. The viewer is designed to look and act like a browser, but is actually a Windows program written in C++ and incorporating some HTML code.

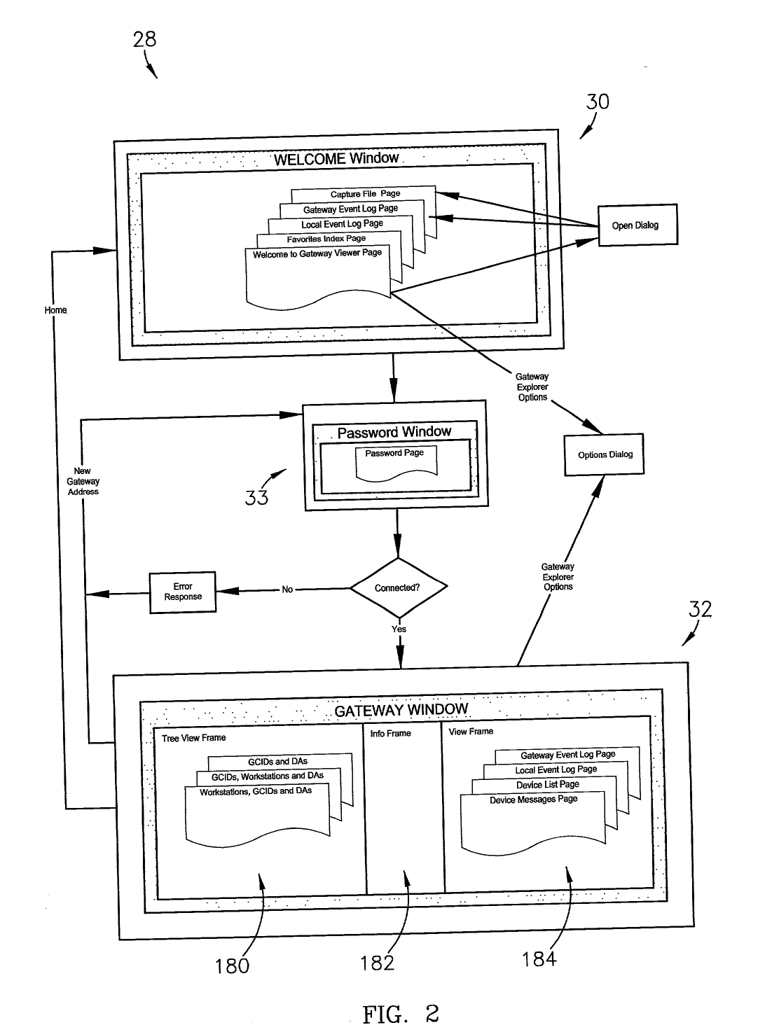

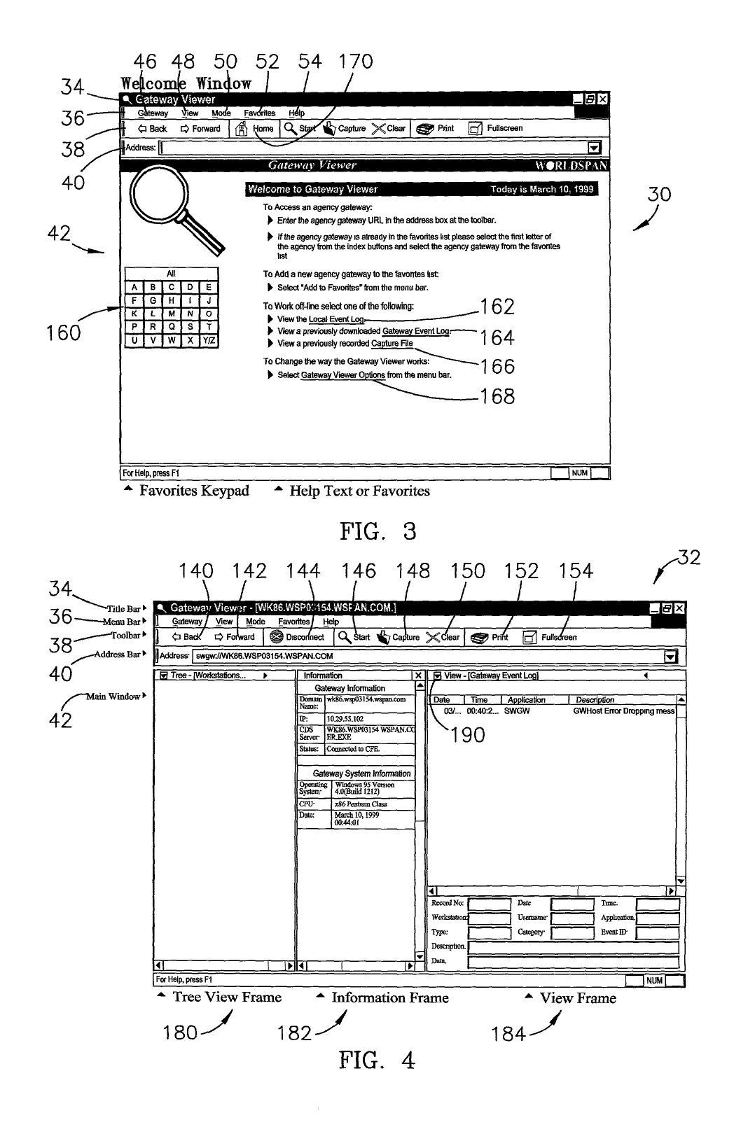

As depicted in FIG. 2, the gateway viewer 28 comprises two primary computer generated and displayed windows for conveying information and manipulating the gateway's functionality, the Welcome Window 30 and the Gateway Window 32. Referring also to FIGS. 3 and 4, both are presented in a “browser” type format having similar, if not identical, header portions including a title bar 34, menu bar 36, toolbar 38, address bar 40, and main window portion 42. It is within the main window portion of the gateway viewer 28 that the controls and information presented by the Welcome Window 30 and Gateway Window 32 vary.

The title bar 34 is operable to display the name or address of the currently connected and selected gateway.

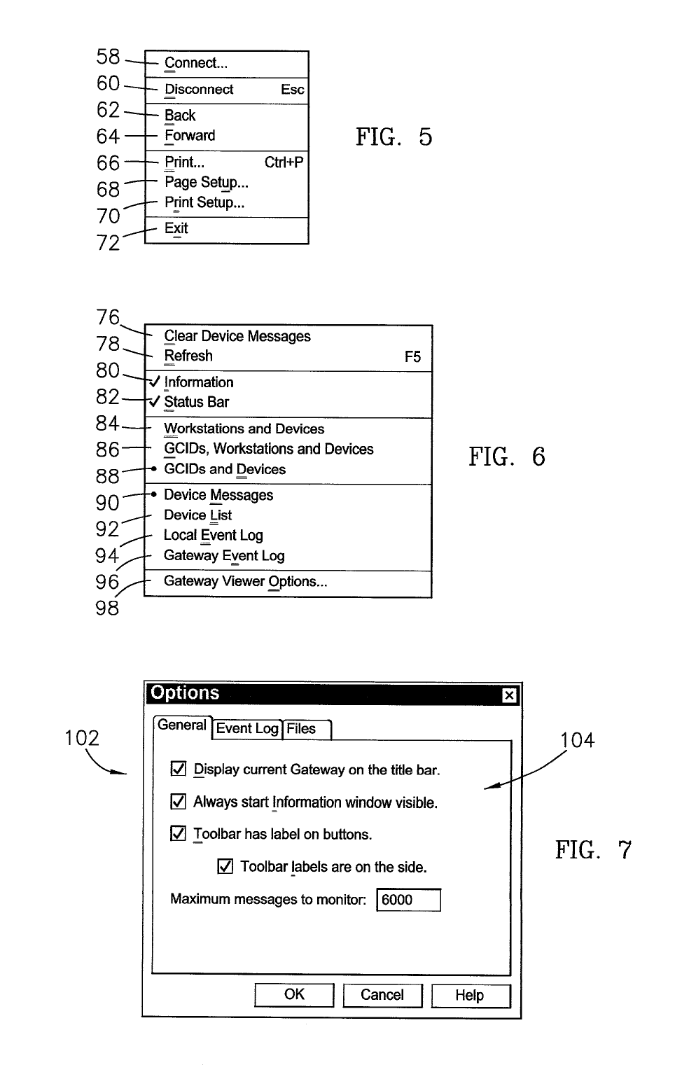

The menu bar 36 includes a Gateway menu 46; a View menu 48; a Mode menu 50; a Favorites menu 52; and a Help menu 54, all of which are conventional drop-down-type menus presenting user-selectable text or symbols, the selection of which results in the performance of a corresponding function. Referring also to FIG. 5, the Gateway menu 46 allows connection and disconnection to gateways and controls print functions. Selecting Connect 58 displays a dialog box allowing the user to connect to a particular gateway by entering directly its name directly into an address field or by selecting a previously identified gateway from a drop-down list box. The dialog box can also be used, by entering a pathname or locating and selecting a file using a conventional file browsing function, to open a Local Event Log or stored Gateway Event Log (*.log) or Capture File (*.cap) stored in the client device's memory.

Selecting Disconnect 60 from the Gateway menu breaks the connection to the currently connected gateway. Selecting Back 62 or Forward 64 connects to the last or next gateway accessed, if any, since the current gateway viewer session began. The Forward 64 function is enabled only if the Back function 62 has been used. Selecting Print 66 prints a Gateway Tree Report of the device tree. Selecting Page Setup 68 displays a modeless dialog box for specifying various parameters associated with printing the Gateway Tree Report, including header and margins. Selecting Print Setup 70 displays the standard Windows Print Setup dialog box. Selecting Exit 72 exists the gateway viewer program.

Referring to FIG. 6, the View menu 48 allows changes to a plurality of screen display preferences, particularly with regard to the nature and formatting of the information displayed. Selecting Clear Device Messages 76 clears monitored host data from the View Frame. Selecting Refresh 78 refreshes the screen. Of the checkable preferences, Information 80 displays the Information Frame if checked, and hides the Information Screen if unchecked. Status Bar 82 displays a status bar if checked, and hides the status bar if unchecked.

The Workstations and Devices; GCIDs, Workstations, and Devices; and GCIDs and Devices options 84,86,88 control the nature of the information shown in the Tree Control. Only one such option 84,86,88 can be selected at a time; an option 84,86,88 is selected if a bullet appears adjacent the option. Workstations and Devices 84 is the default view displayed when the program is first executed. This view arranges devices by workstation, device type (e.g., CRT printer, file) and GCID and DA so that the user may easily see what devices and peripherals are attached to each workstation. For example, support personnel may select the Workstations and Devices option 84 when they desire to see how each workstation is configured.

The GCIDs, Workstations, and Devices option 86 arranges devices by GCID, and organizes the view so that it is easy to see what is attached to each GCID. Support personnel may select this view when troubleshooting a problem involving a particular GCID and DA and desiring information about an attached workstation. Note: A workstation could appear in more than one GCID if it is configured with multiple GCIDs.

The GCIDs and Devices option 88 arranges devices by GCID and DA so that it easy to see the DAs attached to each GCID without viewing any workstation information. Icons for each DA indicate the type of device associated with the DA.

Selecting Device Messages 90 displays host messages for DAs that have been selected for monitoring in the View Frame. Selecting Device List 92 displays a list of DAs that have been selected for monitoring in the View Frame. Host messages for DAs selected on this list will display when Device Messages 90 is selected. Selecting Local Event Log 94 displays the event log of a gateway local to where the Gateway Viewer program is running. Selecting Gateway Event Log 96 displays the event log of a remote gateway.

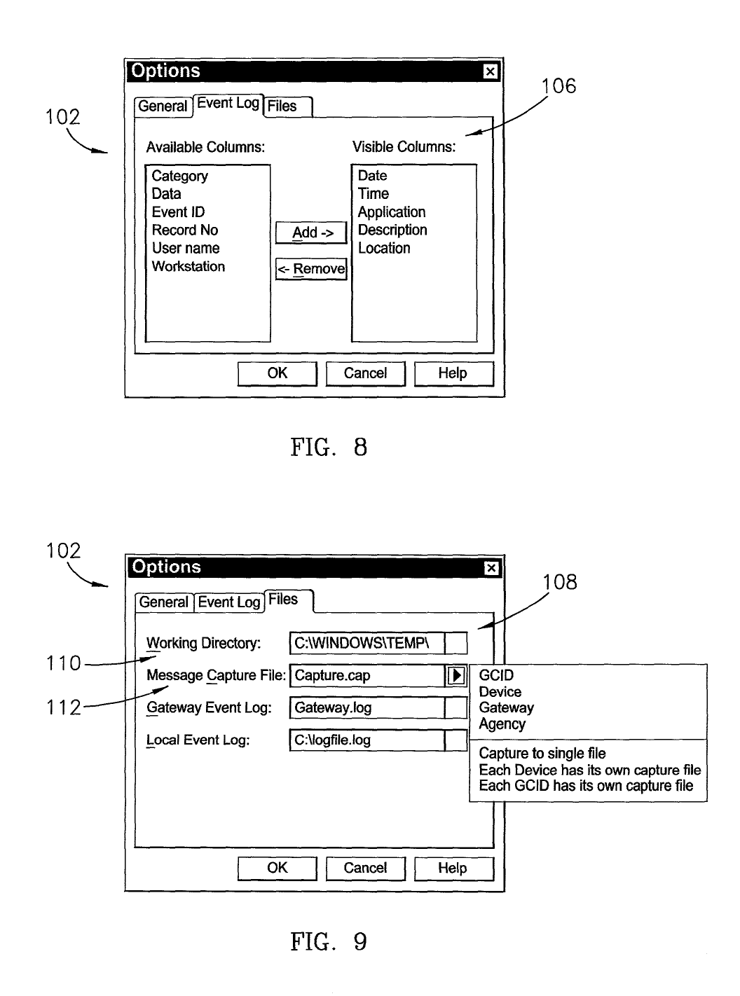

Referring to FIGS. 7, 8, and 9, selecting Gateway Viewer Options 98 displays an Options Tab Control box 102. The Options Tab Control box 102 comprises three tab-selectable displays, including a General tab 104; an Event Log tab 106; and a Files tab 108. The General tab 106 presents options that allow a user to control information displayed in the title bar 34, whether to default-display the Information Frame on start-up, whether the toolbar 34 includes labels and where the labels are positioned relative to their corresponding icons, and the maximum number of messages that may be saved in memory and displayed in the Device Messages 90 view at one time (default value is 6000).

The Event Log tab 106 allows support personnel to add or remove columns from the Gateway or Local Event Log displays. A user may view available columns not currently selected for visibility, select a desired column, and add that column to the list of visible columns. The user may also view currently visible columns and remove a selected column from the list of visible columns.

The Files tab 108 allows support personnel to enter the names of files wherein logs or host messages are to be saved. Under the Files tab 108, the user may specify the name of a file used to store captured monitored data for later examination, or the name of a file used to store a captured Gateway Event Log or a Local Event Log. Such file identification is accomplished by either directly entering a file name, selecting an existing filename using a conventional browsing function, or by selecting specific file name components (e.g., GCID, Device, Gateway, Agency) from a selectable pop-up menu. The pathname appearing in the Working Directory field 110 will be the default pathname used unless a different pathname is specified in the appropriate field 112,114,116.

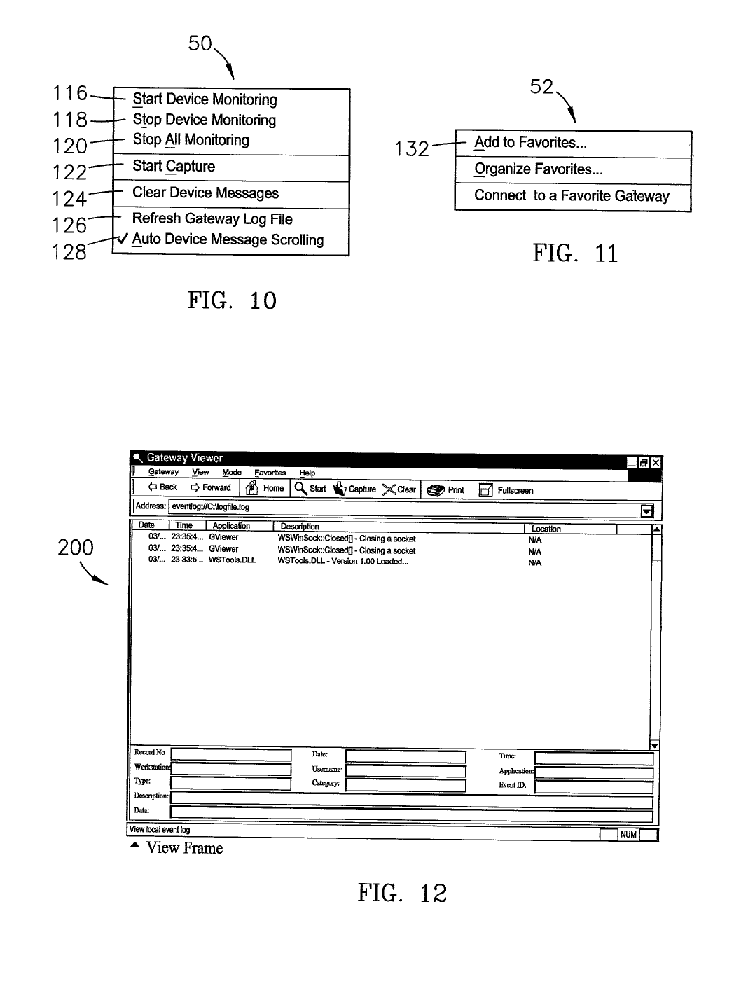

Referring to FIG. 10, the Mode menu 50 may be used to start and stop host data monitoring and capture.

Selecting Start Device Monitoring 116 captures data from the DA selected on the Tree View Frame. Start Device Monitoring 116 is not allowed if the DA selected is already being monitored or if the DA has not been selected from the Tree Control.

Selecting Stop Device Monitoring 118 stops data capture from the DA selected on the Tree View Frame. Stop Device Monitoring 118 is not allowed if the DA selected is not already being monitored or if the DA has not been selected from the Tree Control.

Selecting Stop All Monitoring 120 stops data capture for all DAs previously selected for monitoring.

Selecting Start Capture 122 stores highlighted host inputs and outputs to a file in the memory of the device running the Gateway Viewer. A user desiring to view the captured filename must select Gateway Viewer Options 98 from the View Menu 48 (described above), select the Files tab 108, and enter a new name in the Message Capture File 112 field.

Selecting Clear Device Messages 124 clears all messages displayed in the View Frame. Selection of this function is not allowed if there are no messages displayed.

Selecting Refresh Gateway Log File 126 gathers and displays the most current information in the Gateway Log File. Selection of this function is not allowed if the Gateway Event Log is not the active View Frame.

Checking Auto Device Message Scrolling 128 causes messages to scroll on the display or monitor screen as they are gathered from the device. If unchecked, messages are gathered but the screen does not scroll. Selection of this function is not allowed if Device Messages is not the active View Frame.

Referring to FIG. 11, the Favorites menu 52 may be used to display for selection “favorite” or frequently used or accessed gateways.

Selecting Add to Favorites 132 displays a modal dialog box wherein a descriptive name of a gateway may be entered. The gateway FQDN or IP address is captured automatically from the address bar 40 to appear by default in the dialog box. The name can be changed, however, to a more meaningful and easy to remember gateway identifier, either by appending to or replacing the FQDN or IP address. Selection of this function is only allowed when connected to a valid gateway, so that only legitimate gateway addresses can be saved.

Selecting Organize Favorites 134 displays a modal box showing a list of stored descriptive names and addresses of gateways sorted by name. From this dialog box, these stored names may be edited or deleted.

Selecting Connect to a Favorite Gateway 136 displays a modal dialog box showing a list of stored descriptive names and addresses of favorite gateways, from which the user may select a gateway for connection.

The Help menu 54 displays a dialog box presenting a list of selectable help topics.

The Toolbar 38 includes a number of selectable icons and, where enabled, corresponding descriptive labels, the selection of which results in performance of a particular function.

Selecting Back 140 returns to a previous gateway. Selecting Forward 142 advances to a subsequent gateway from a previous one. Selecting Disconnect 144 disconnects from the current gateway.

Selecting Start 146 begins monitoring host data for a selected DA. Selection of this function is allowed only when the DA currently selected on the Tree Control is not already being monitored.

Selecting Stop (not shown) terminates monitoring of host data for a selected DA. Selection of this function is allowed only when the DA currently selected on the Tree Control is being monitored.

Selecting Capture 148 sends selected host data to a file specified in the Gateway Viewer Options, Files tab control. Selecting Clear 150 clears monitored data from the View Screen. Selecting Print 152 prints the device tree.

Selecting Fullscreen 154 toggles between Full screen and the screen's previous size and location. When Fullscreen is selected, the title bar 34 is no longer displayed.

The address bar 40 is a so-called “combo box” operable to accept an IP address or FQDN of a gateway. As gateway connections are made, the address bar 40 stores previous connections for selection from a drop down list.

As mentioned able, the main window 42 defines the screen or display area within which a number of specialized windows or frames will appear when selected or enabled. Referring again to FIG. 3, when the enterprise software gateway is executed, the Welcome Window 30 appears in the main window portion 42 of the viewer, from which a user may connect to a particular gateway, either by directly entering the desired gateway's FQDN or IP address in the address bar 40 or by selecting via the drop down menus (described above) the gateway from a favorites list or a previously saved log or capture file.

Gateway names can also be selected using a graphical Favorites Keypad 160 which presents alphanumeric icons in the form of a keypad, the keys of which are individually selectable to call up a list or index of favorite gateways. Selecting the key representing the first letter of the desired gateway's name or identifier will cause to be display all saved gateway names starting with the selected letter. Selecting the All key will display a comprehensive list of all saved gateways.

Once the gateway has been selected or otherwise identified, a Password Window 33 will be displayed requesting a valid User ID and Password, the entering of which results in an attempt to connect. If connection is successful, the Gateway Window 32 will be displayed, as shown in FIG. 4. Also from the Welcome Window 30, saved Log or Capture Files can be displayed.

A number of selectable hyperlinks appear in the Welcome Screen 30, including Local Event Log 162; Gateway Event Log 164; Capture File 166; and Gateway Viewer Options 168.

Referring also to FIG. 2, selecting the Local Event Log hyperlink 162 will display an event log from the local gateway where the Gateway Viewer is running. This is a convenient way to display errors received on the local gateway.

Selecting the Gateway Event Log hyperlink 164 will display a list of saved Event Logs from remote gateways. Once the selection has been made, an Open dialog box will appear displaying the default directory for saved logs. All filenames in the directory with a log extension are displayed. After a particular Log File has been selected, the log will display in the Welcome Window 30. FIG. 12 shows an exemplary display 200 of Local Event Log contents.

Selecting the Capture File hyperlink 166 will display a list of saved Capture Files containing monitored host data from remote gateways. Once the selection has been made the Open dialog box will appear displaying the default directory for saved capture files. All filenames in the directory with a cap extension are displayed. After a particular Capture File has been selected, the file will display in the Welcome Window 30.

Where a Local Event Log, Gateway Event Log, or Capture File is displayed in the Welcome Window 30, selecting Home 170 from the toolbar 38 clears the Gateway Event Log and returns to the default Welcome Window 30 view shown in FIG. 3.

Selecting the Gateway Viewer Options hyperlink 168 is selectable to display the Options dialog box. The Options dialog box can also be displayed from the Gateway Viewer Options on the View Menu (described above).

After a gateway has been selected in the Welcome Window, a Password Window 33 will appear with which the user may attempt to successfully login to the gateway. In one embodiment, normal identifiers, such as client and user IDs and passwords, are stored in a local CDS, and super-user identifiers are stored in a Central Authentication Server. After entering a client ID, a username, and a password, selecting connect or striking ENTER will initiate an attempt to connect to the specified gateway.

Referring again to FIG. 4, after a successful login via the Password Window 33, the Gateway Window 32 appears with client configuration information. The primary purpose of the Gateway Viewer is to allow support personnel to view the Gateway Event Log from a remote client or to monitor actual host traffic received by the gateway for an individual or a group of selected DAs, and the Gateway Window 32 is where this information is displayed. After support personnel enters the IP address or FQDN of a gateway and successfully connects, the Gateway Window 32 displays information about any devices connected to that gateway. The main window 42 is divided into three portions or frames: a Tree View Frame 180; an Information Frame 182; and a View Frame 184. All three frames are resizable and can be adjusted as needed.

The Tree View Frame 180 presents a Tree Control showing all devices configured for the connected gateway. Three different views are available, including Workstation and Devices view; GCIDs, Workstations, and Devices view; and GCIDs and Devices view. These views are selectable via the View menu 48 described above, or alternatively, may be selected from a Tree View Frame Toolbar appearing at the top of the Tree View Frame selectable to display a drop-down menu presenting the three view choices. The default Workstations and Devices view is shown in FIG. 4. After initial connection to the gateway, the view last selected appears. Interactive devices, which are turned off or not running specific client applications, are easily identified. Active devices can be selected for device monitoring.

The Workstations and Devices view arranges devices by workstation, type (e.g., CRT, Printer, File), and GCID and DA. This view may be used, for example, by support personnel desiring to view each or a particular workstation's configuration. To facilitate quick understanding, an icon precedes each control tree identifier. Such representative icons may include icons corresponding to an active or inactive GCID; individual or lists of pools; or active or inactive workstations, CRTs, DIRs, printers, files, or client applications.

The Workstations and Devices view is also operable to communicate all Gateway Viewers currently connected to the particular gateway. Each Viewer is identified with progressive two digit numbers (e.g., 00, 01, 02), and each monitored device is identified by GCID and DA. Selecting such a device from the Tree Control will reveal in the Information Frame the actual username and IP address of the viewing person.

The GCIDs, Workstations, and Devices view arranges devices by GCID and communicates which workstation and device types (e.g., CRT, printer, file) are associated with each GCID. Icons are used in this view as well to facilitate quick understanding of the displayed information.

The GCIDs and Devices view arranges devices by GCID and DA. This view may be used, for example, by support personnel wanting to find a specific DA quickly. Icons are used in this view as well to facilitate quick understanding of the displayed information.

The Information Frame 182 shows status information and statistics gathered about a selected gateway, GCID, DA, CRT, or printer, including the beginning of the last input and output blocks and the times they were sent and received. The Information Frame 182 will also communicate whether a printer is in a ready or a busy state. The Information Frame 182 can be resized larger or smaller, or closed.

If a gateway is selected, the Information Frame 182 displays such information as FQDN or IP address, operating system version, memory allocation, and processes running on the gateway. If a GCID is selected, the Information Frame 182 displays basic statistics about the GCID. If a DA is selected, the Information Frame 182 displays such information as type and status of the device, last incoming and outgoing messages, and message times. The format of the GCID and DA information is the same as the status message returned in the Status Request and Status Response Message using MATIP protocol.

While information is being gathered for display in the Information Frame 182, an advisory message will be displayed to that effect. When the gateway has been rebooted since the last host request/response, certain statistics will not be displayed for GCIDs or DAs because these statistics are cleared during the reboot.

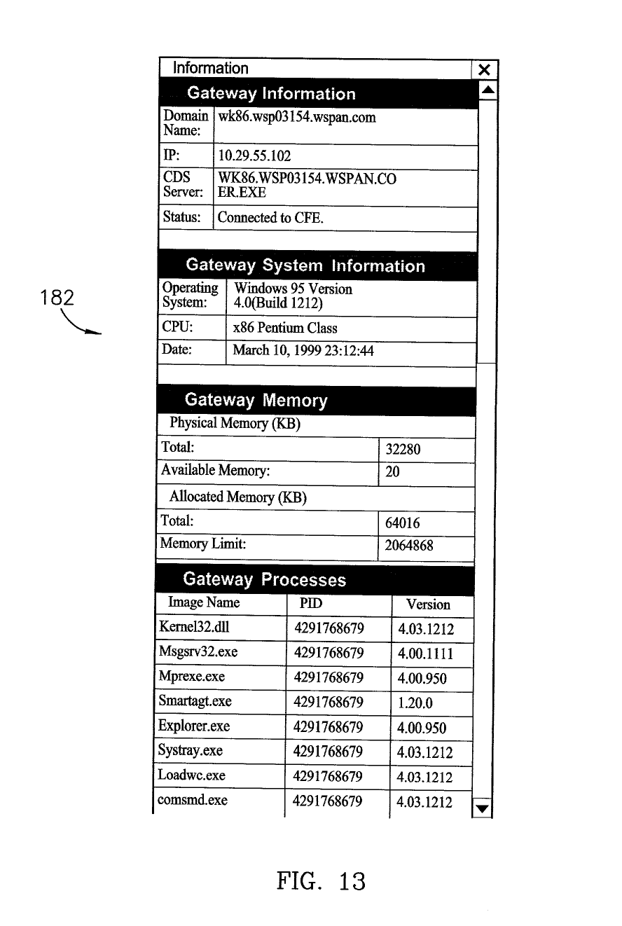

FIG. 13 shows an exemplary Information Frame 182 for a selected gateway wherein certain headings relate to specific information of interest, for example:

| | |
|---|---|
| Domain Name | gateway FQDN; |
| IP | gateway IP address; |
| Name | user-supplied gateway identifier; |
| CDS Server | FQDN of gateway's CDS server; |
| Status | gateway-to-CFE connection (connected/not |
| | connected); |
| Operating System | gateway operating system; |
| CPU | gateway CPU; |
| Image Name | software name; |
| PID | process identification number; |
| Version | software version. |

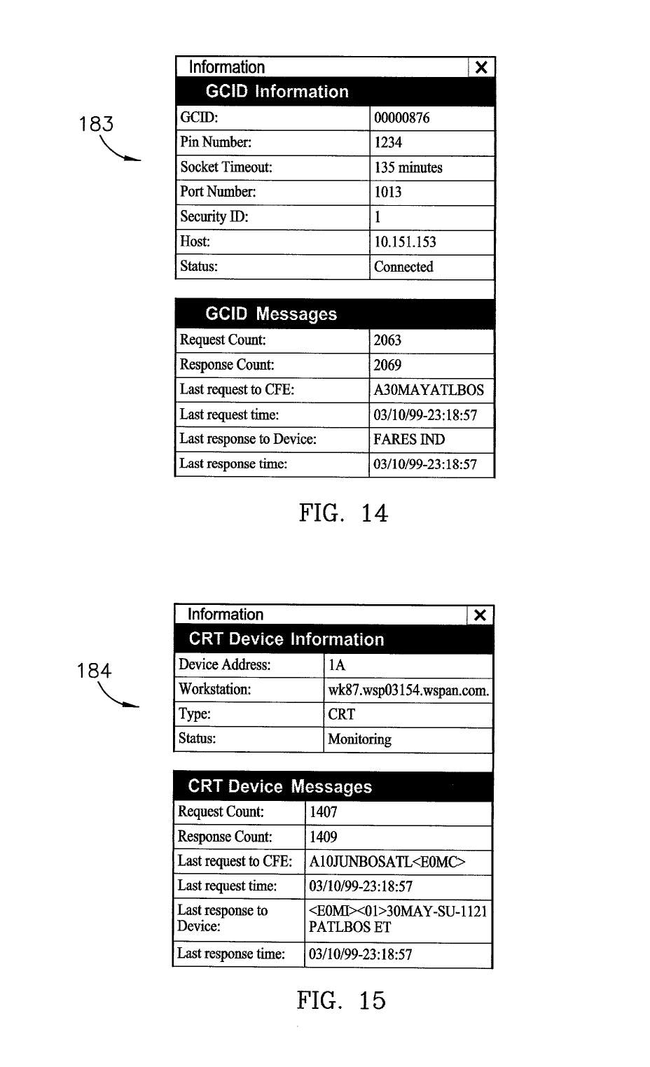

FIG. 14 shows an exemplary Information Frame 183 for a selected GCID, wherein certain headings relate to specific information of interest, for example:

| | |
|---|---|
| GCID | GCID number; |
| Pin Number | pin configured for this GCID; |
| Socket Timeout | minutes of activity required for timeout; |
| Port Number | communications port; |
| Security ID | security ID configured for this GCID; |
| Host | host CFE IP address; |
| Status | status of GCID-to-CFE connection; |
| Request Count | messages to CFE for GCID since reboot; |
| Response Count | messages from CFE to GCID since reboot; |
| Last Request to CFE | start of last message block to CFE; |
| Last Request Time | time last block sent from gateway to CFE; |
| Last Response to Device | start of last block received by gateway for this |
| | GCID; |
| Last Response Time | time last message block sent to gateway for this |
| GCID. | |

FIG. 15 shows an exemplary Information Frame 184 for a selected DA, wherein certain headings relate to specific information of interest, for example:

| | |
|---|---|
| Device Address | DA; |
| Workstation | workstation FQDN; |
| Type | Device type; |
| Status | DA-to-gateway status (connected/not |
| | connected); |
| Request Count | messages from CFE to DA since last reboot; |
| Response Count | messages from DA to CRS since last reboot; |
| Last Request to CFE | beginning of last block from DA to CRS; |
| Last Request Time | gateway time of last block from DA to CRS; |
| Last Response to Device | beginning of last block from CRS to DA; |
| Last Response Time | gateway time of last block from CRS to DA. |

The View Frame 184 displays either the Local Event Log view; remote Gateway Event Log view; Device Messages view of currently selected DAs; or a Device List view showing currently monitored DAs. By default, the View Frame 184 displays the Device Messages view, which will be blank until devices are selected to monitor. These views are selectable from a drop-down View Frame menu 190.

The Device Messages view communicates host activity received by and sent from the gateway for a specific DA or multiple DAs selected for monitoring. For each DA for which this function is desired, the user must select the DA from the Tree Frame view 182 and initiate host monitoring by either selecting the Start button 146 on the toolbar 38, selecting Start Device Monitoring from the Tools menu, or right-clicking and selecting Start. When monitoring starts, the device will change to red in the Tree Control to indicate that monitoring is active. The View Frame 184 can display input and output from the selected single or multiple DAs simultaneously.

The Device List view displays a list of devices actively monitored at the time. Actively monitored devices will be marked in red on the Tree Control. When monitoring multiple devices simultaneously, the Device List view is used to display host traffic from or to a single device and display only those entries and responses for that specific device. Information is actively gathered for all devices on the list even though they may not be checked. The display may be limited to a single device by unchecking all other listed devices, though monitoring of those devices will continue. The information displayed may be further limited, as desired, to entries sent to the host or responses sent from the host. If active message monitoring of a particular DA is stopped, the DA will remain checked in the device list and previously gathered messages remain present until cleared by the user.

The Local Event Log view displays the event log stored on the local gateway of the user running the Gateway Viewer program. The Gateway Viewer provides the option to display the Local Event Log to facilitate troubleshooting of a local workstation. The Local Event Log display is refreshed automatically.

The Gateway Event Log view displays the event log stored on the remote gateway specified in the Gateway Address Bar. The event log records communication errors occurring between the gateway and the host or the individual devices connected to the gateway. The Gateway Event Log is presented in a format similar to the Local Event Log. The Gateway Event Log displayed must be refreshed manually.

Although the invention has been described with reference to the preferred embodiment illustrated in the attached drawing figures, it is noted that equivalents may be employed and substitutions made herein without departing from the scope of the invention as recited in the claims. Those with skill in the art will appreciate, for example, that numerous different embodiments of hardware, software, firmware or combinations thereof exist for practicing the present invention. Accordingly, the present invention should not be viewed as limited to the particular illustrative embodiment shown and described.

Having thus described the preferred embodiment of the invention, what is claimed as new and desired to be protected by Letters Patent includes the following:

1. A system comprising:
a host system operable to communicate information over a network using a first protocol;
a client system operable to execute a client application and communicate information over the network using a second protocol; and
a gateway operable to perform protocol conversion between the first and second protocols and to manage the communication of information between the host and client systems;
wherein the gateway includes a viewer interface operable to communicate information to a remote site regarding functioning of the gateway and further operable to allow for control and configuration of the gateway from the remote site.

2. The system as set forth in claim 1, wherein the gateway operates at a different physical location relative to the client system, and is operable to support a plurality of client systems simultaneously.

3. The system as set forth in claim 1, wherein the gateway provides multiple interfaces for use by the client system, including a TCP/IP socket interface.

4. The system as set forth in claim 3, wherein the TCP/IP socket interface supports a packet encoding schema to prevent changing information communicated between the client system and the gateway.

5. The system as set forth in claim 1, wherein the gateway provides filtering operable to allow the client system to selectively intercept information communicated by the host system.

6. The system as set forth in claim 1, wherein the gateway provides a multithreaded message queuing protocol that allows the client system to communicate with the host system using structured data records.

7. A system comprising:
a legacy host system operable to communicate information over a network using a first protocol;
a client system operable to execute a client application and communicate information over the network using a second protocol; and
a gateway operable to perform protocol conversion between the first and second protocols and to manage the communication of information between the host and client systems;
wherein the gateway provides a multithreaded message queuing protocol that allows the client system to communicate with the host system using structured data records.

8. The system as set forth in claim 7, wherein the gateway includes a viewer interface operable to communicate information to a remote site regarding functioning of the gateway and further operable to allow for control and configuration of the gateway from the remote site.

9. The system as set forth in claim 7, wherein the gateway operates at a different physical location relative to the client system, and is operable to support a plurality of client systems simultaneously.

10. The system as set forth in claim 7, wherein the gateway provides multiple interfaces for use by the client system, including a TCP/IP socket interface.

11. The system as set forth in claim 10, wherein the TCP/IP socket interface supports a packet encoding schema to prevent changing information communicated between the client system and the gateway.

12. The system as set forth in claim 7, wherein the gateway provides filtering operable to allow the client system to selectively intercept information communicated by the host system.

13. A combination of code segments stored on computer-readable memory and executable by a computing device to facilitate an interface between a host and a client, the combination of code segments comprising:
a code segment operable to monitor communication between the host and client and to create a log representative of the monitored communication;
a code segment for creating a viewer operable to communicate information to a remote site regarding the monitored communication, including the log, and functioning of the computing device; and
a code segment operable to allow configuration and control of the computing device from the remote site.

14. The combination of code segments as set forth in claim 13, wherein the code segment creating the viewer is further operable to format the information into a number of different user-selectable display formats.

15. The combination of code segments as set forth in claim 13, operable to provide a multithreaded message queuing protocol that allows the client system to communicate with the host system using structured data records.

16. The combination of code segments as set forth in claim 13, further including a code segment operable to support a plurality of client connection, including a TCP/IP socket interface.

17. The combination of code segments as set forth in claim 16, further including a code segment operable to provide a packet encoding schema to prevent changing information communicated between the client system and the gateway.

18. The combination of code segments as set forth in claim 13, further including a code segment operable to provide filtering to allow the client system to selectively intercept information communicated by the host system.

19. The combination of code segments as set forth in claim 13, further including a code segment operable to provide a multithreaded message queuing protocol that allows a client system to communicate with a host system using structured data records.

20. A computer-generated display viewer operable to facilitate monitoring and control of a gateway, including remote monitoring and display of communication via the gateway between a host system and a client system, the computer-generated display being stored on computer-readable media and executable by a computing device and comprising
a first data input mechanism with which a particular gateway can be user-indicated;
a main window operable to display information related to the user-indicated particular gateway, with the information being of a user-selected nature and format, including errors, warnings, success events, events occurring, and status; and
a second data input mechanism with which functionality of the particular gateway can be controlled.

21. The computer-generated display viewer as set forth in claim 20, wherein the first and second data input mechanisms are selected from the group consisting of the following computer-generated elements: icons, symbols, buttons, hyperlinks, drop-down menus, pop-up menus, address bars.

22. The computer-generated display viewer as set forth in claim 20, being further operable to create a log related to the remotely monitored communications and save the log on computer-readable media for subsequent recall and display.
